(19) United States
(12) Patent Application Publication
(10) Pub. No.: US 2022/0405713 A1
(43) Pub. Date: Dec. 22, 2022

(54) THIRD-PARTY RESOURCE MANAGEMENT FROM CALENDAR APPLICATION

(71) Applicant: Microsoft Technology Licensing, LLC, Redmond, WA (US)

(72) Inventors: Balagopal CHENICHERI, Renton, WA (US); Shabnam ERFANI, Kirkland, WA (US); Venkata Sreekanth KANNEPALLI, Redmond, WA (US); Wende E. COPFER, Woodinville, WA (US); Ashwini LAKSHMI NARASIMHAN, Redmond, WA (US); Jin Young KIM, Seattle, WA (US)

(73) Assignee: Microsoft Technology Licensing, LLC, Redmond, WA (US)

(21) Appl. No.: 17/350,928

(22) Filed: Jun. 17, 2021

(51) Int. Cl. G06Q 10/10; G06Q 10/08

(52) U.S. Cl. CPC G06Q 10/1095; G06Q 10/1091; G06Q 10/087

(57) ABSTRACT

A calendar application server, a computer-readable storage medium, and corresponding methods for third-party resource management within the context of a calendar application are described herein. The computer-readable storage medium includes computer-executable instructions that, when executed one or more processors, cause the processor(s) to associate a third-party resource with an event within a calendar application in response to a user command received via an event UI functionality provided by the calendar application, to connect with the third-party resource via an API corresponding to the third-party resource in response to another user command received via the event UI functionality (where the API is provided within the context of the calendar application), to generate third-party resource data for the event in response to user interaction with the third-party resource via the API, and to reconcile the third-party resource data with event data within the calendar application.

### BACKGROUND

The present disclosure relates to third-party resource management. In particular, the present disclosure relates to managing third-party resources for an event within the context of a calendar application.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In an embodiment described herein, a calendar application server is described. The calendar application server includes a processor and a computer-readable storage medium operatively coupled to the processor. The computer-readable storage medium includes computer-executable instructions that, when executed by the processor, cause the processor to enable execution of a calendar application on a first remote computing system corresponding to a first calendar, where the first remote computing system is communicably coupled to the calendar application server through a network, as well as to provide a first event user interface surfaced on a first display of the first remote computing system in response to a user-initiated creation of an event with respect to a first calendar within the calendar application. The computer-executable instructions, when executed by the processor, also cause the processor to associate a third-party resource with the event within the calendar application in response to a first user command received via the first event user interface and to transmit an event invitation to a second remote computing system corresponding to a second calendar in response to a second user command received via the first event user interface, where the second remote computing system is communicably coupled to the calendar application server through the network. The computer-executable instructions, when executed by the processor, also cause the processor to enable execution of the calendar application on the second remote computing system, to associate the event with the second calendar and provide a second event user interface surfaced on a second display of the second remote computing system in response to a user-initiated acceptance of the event invitation, and to connect with the third-party resource associated with the event via an application programming interface corresponding to the third-party resource in response to a third user command received via the second event user interface, where the application programming interface is provided within the context of the calendar application. The computer-executable instructions, when executed by the processor, further cause the processor to generate third-party resource data for the event in response to a user interaction with the third-party resource via the application programming interface, as well as to reconcile the third-party resource data with event data corresponding to the event within the calendar application such that the event is updated with respect to the first calendar and the second calendar.

In another embodiment, a computer-readable storage medium is described. The computer-readable storage medium includes computer-executable instructions that, when executed by at least one processor, cause the at least one processor to associate a third-party resource with an event within a calendar application in response to a first user command received via an event user interface functionality provided by the calendar application, as well as to connect with the third-party resource via an application programming interface corresponding to the third-party resource in response to a second user command received via the event user interface functionality provided by the calendar application, where the application programming interface is provided within the context of the calendar application. The computer-executable instructions, when executed by the at least one processor, also cause the at least one processor to generate third-party resource data for the event in response to a user interaction with the third-party resource via the application programming interface provided within the context of the calendar application, as well as to reconcile the third-party resource data with event data corresponding to the event within the calendar application.

In another embodiment, a method for interacting with a third-party resource associated with an event within the context of a calendar application is described. The method is implemented in a computing system including a processor and a display operatively coupled to each other. The method includes executing, via the processor, the calendar application on the computing system, receiving, via the calendar application, an event invitation for an event including an associated third-party resource, and receiving, via the calendar application, a first user input including a command to provide an event user interface corresponding to the event. The method also includes providing the event user interface surfaced on the display in response to the first user input, receiving, via the event user interface, a second user input including a command to accept the event invitation, and associating the event with a calendar within the calendar application and providing an option to access the associated third-party resource via the event user interface in response to the second user input. The method also includes receiving, via the event user interface, a third user input including a command to access the third-party resource, as well as connecting with the third-party resource through an application programming interface corresponding to the third-party resource in response to the third user input, where the application programming interface is provided within the context of the calendar application. The method further includes receiving, via the event user interface, a fourth user input including a command to interact with the third-party resource via the application programming interface, interacting with the third-party resource via the application programming interface in response to the fourth user input to generate third-party resource data for the event, and reconciling the third-party resource data with event data corresponding to the event within the calendar application such that the event is updated with respect to the calendar.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a process flow diagram of a method for enabling third-party resource management for an event within the context of a calendar application according to embodiments described herein;

FIG. 2 is a process flow diagram of a method for managing a third-party resource for an event within the context of a calendar application according to embodiments described herein;

FIG. 3 is a process flow diagram of a method for interacting with a third-party resource associated with an event within the context of the calendar application according to embodiments described herein;

FIG. 4 is a block diagram of an exemplary computing system for implementing the third-party resource management techniques described herein;

FIG. 5 is a block diagram of an exemplary network environment for implementing the third-party resource management techniques described herein;

FIG. 6 is a block diagram of an exemplary computer-readable storage medium for implementing the third-party resource management techniques described herein;

FIG. 7A is a schematic view of a first event user interface that is overlaid on top of a first calendar user interface within the context of a calendar application, as viewed from the perspective of the event organizer;

FIG. 7B is a schematic view depicting the manner in which the event organizer may click on the user interface element to reveal a corresponding dropdown menu for associating a third-party resource with the event;

FIG. 7C is a schematic view depicting a third-party resource panel that may open within the first event user interface in response to the event organizer selecting the option to add the third-party resource to the event via the dropdown menu;

FIG. 7D is a schematic view depicting exemplary user interface elements provided by the third-party resource panel in response to the event organizer choosing one or more third-party resources (or one or more types of third-party resources) to associate with the event;

FIG. 7E is a schematic view depicting the event user interface and the corresponding third-party resource panel once the event organizer has finished associating the third-party resource(s) with the event;

FIG. 7F is a schematic view depicting an event invitation that is received at a remote computing system that is operated by one of the event attendees;

FIG. 7G is a schematic view depicting the manner in which the second event user interface may provide the event attendee with the option to interact with the third-party resource(s) associated with the event;

FIG. 7H is a schematic view depicting the manner in which the calendar application connects with the third-party resource(s) via a third-party resource connection panel that is provided by (or overlaid onto) the event user interface of the calendar application in response to connection with the third-party resource(s) via corresponding application programming interface(s);

FIG. 7I is a schematic view depicting the manner in which the third-party resource connection panel may display options for selecting goods to order from the third-party resource that is selected by the event attendee;

FIG. 7J is a schematic view depicting a third-party resource confirmation message that may be received by the event attendee in response to the event attendee's interaction with the third-party resource;

FIG. 7K is a schematic view of a third-party resource interaction notification that may be received by the event organizer via the first calendar user interface;

FIG. 8A is another schematic view of a first event user interface that is overlaid on top of a first calendar user interface within the context of a calendar application, as viewed from the perspective of the event organizer;

FIG. 8B is a schematic view depicting exemplary user interface elements provided by the third-party resource panel in response to the event organizer choosing one or more third-party resources (or one or more types of third-party resources) to associate with the event;

FIG. 8C is a schematic view depicting the first event user interface and the corresponding third-party resource panel once the event organizer has finished associating the third-party resource(s) with the event;

FIG. 9A is another schematic view of a first event user interface that is overlaid on top of a first calendar user interface within the context of a calendar application, as viewed from the perspective of the event organizer;

FIG. 9B is a schematic view depicting the manner in which the third-party resource panel may enable the event organizer to select whether to personally interact with the associated third-party resource(s) or to enable the event attendee(s) to interact with the associated third-party resource(s);

FIG. 9C is a schematic view depicting various user interface elements provided by the third-party resource panel in response to the event organizer indicating a desire to personally interact with the third-party resource(s);

FIG. 9D is a schematic view depicting the manner in which the calendar application connects with the third-party resource(s) via a third-party resource connection panel that is provided by (or overlaid onto) the event user interface of the calendar application in response to connection with the third-party resource(s) via corresponding application programming interface(s);

FIG. 9E is a schematic view depicting the manner in which the third-party resource connection panel enables the event organizer to select a desired service from a list of services that meet the search criteria;

FIG. 9F is a schematic view depicting the manner in which the third-party resource connection panel enables the event organizer to view and confirm the scheduled services before the third-party resource data associated with the third-party resource interaction is reconciled with the event data within the calendar application;

FIG. 9G is a schematic view of a third-party resource confirmation message that may be provided within the third-party resource panel in response to the event organizer interacting with the third-party resource;

FIG. 9H is a schematic view of another third-party resource confirmation message that may be received by the event organizer in response to the event organizer's interaction with the third-party resource;

FIG. 10A is a first event user interface that is provided within the context of a calendar application, as viewed from the perspective of the event organizer;

FIG. 10B is a schematic view depicting a third-party resource panel that may open within the first event user interface in response to the event organizer selecting the option to add a new third-party resource to the event via the dropdown menu;

FIG. 100 is a schematic view depicting exemplary user interface elements provided by the third-party resource panel in response to the event organizer selecting the third-party resource(s) (or type of third-party resource) to associate with the event; and

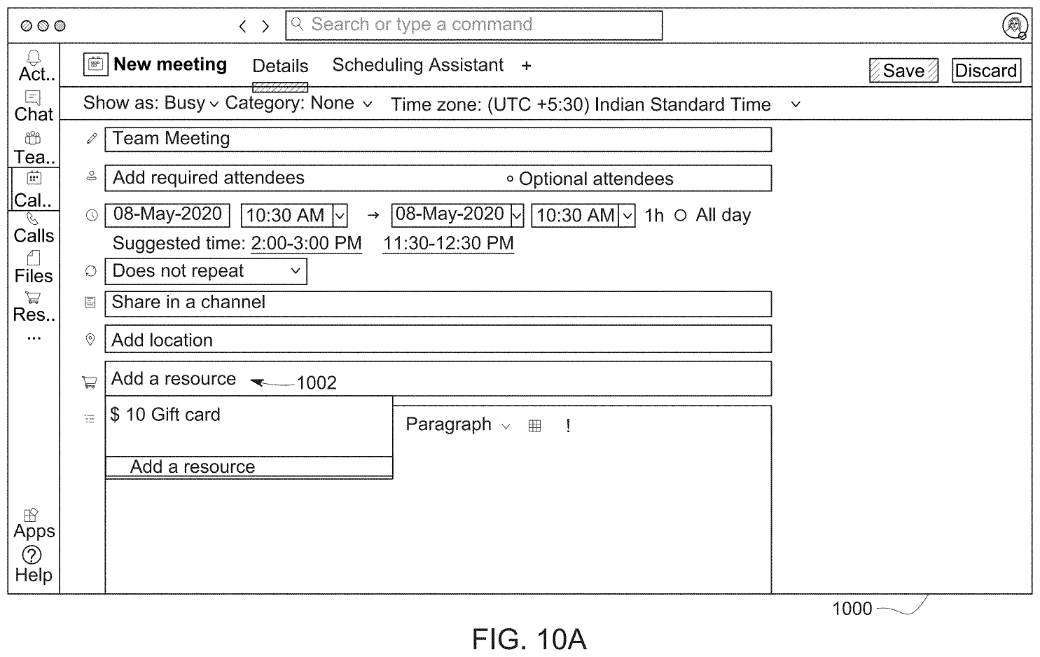

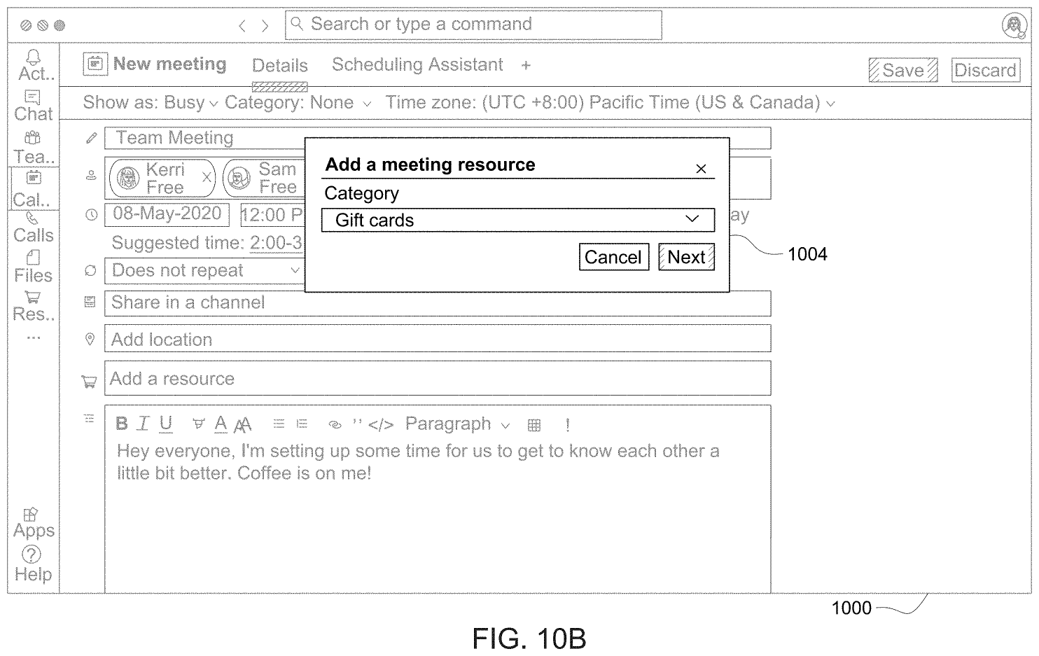

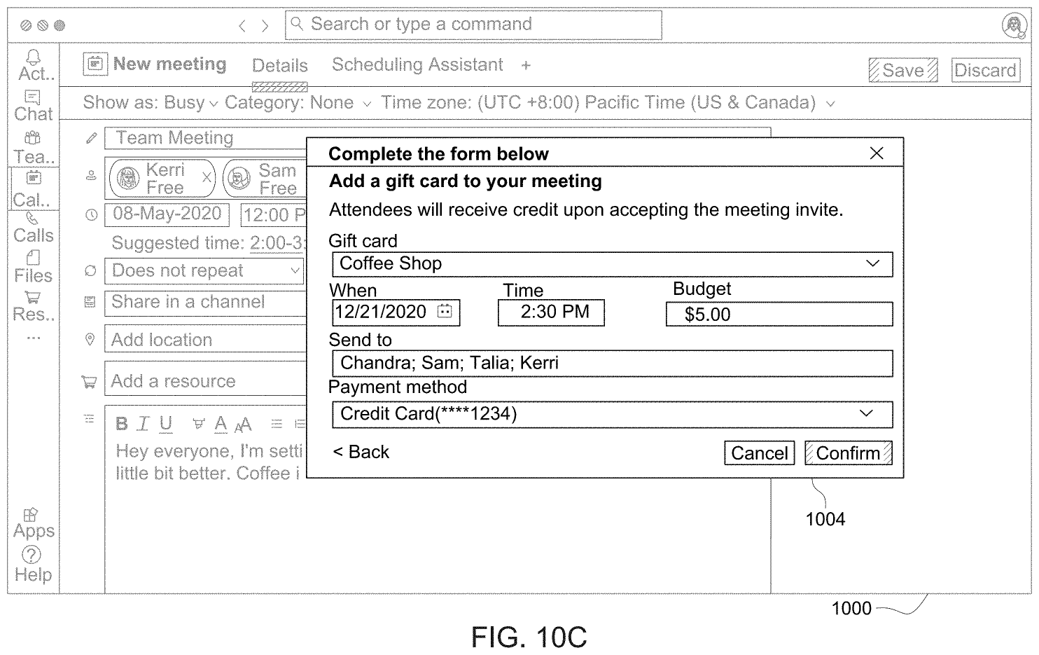

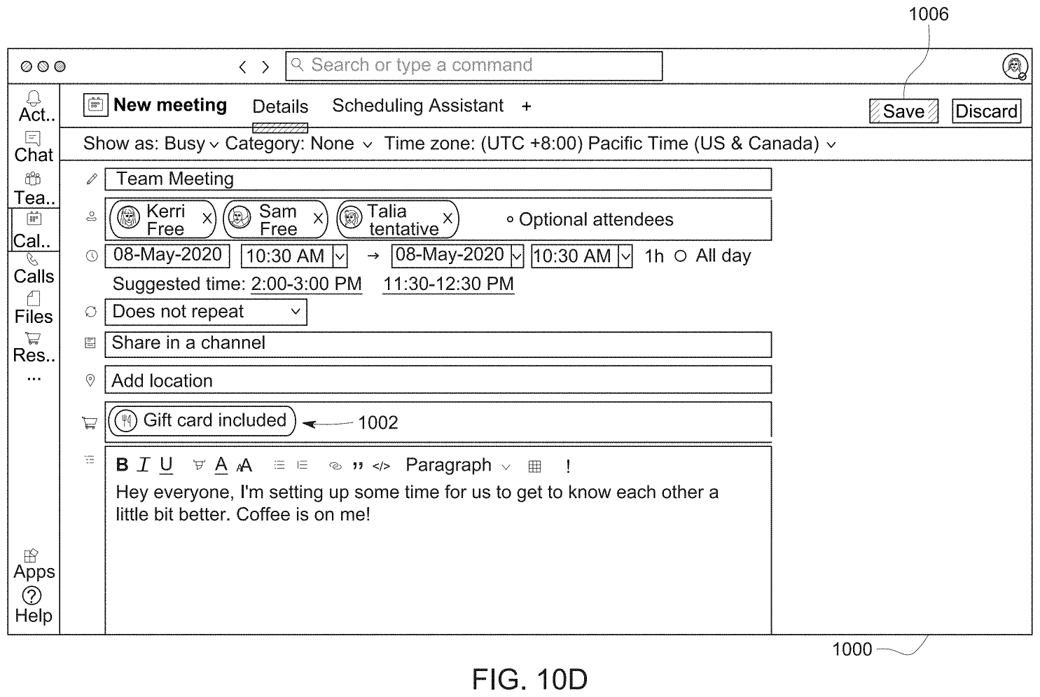

FIG. 10D is a schematic view depicting the first event user interface once the event organizer has finished associating the third-party resource(s) with the event.

### DETAILED DESCRIPTION

In today's environment, the use of calendar applications for time management and scheduling purposes has increased dramatically. In particular, such calendar applications are often used to create and/or manage events, such as virtual or in-person meetings, parties, appointments, conferences, and the like. Furthermore, in many cases, third-party resources are used for such events. As an example, when an event organizer plans a particular event, the event organizer may utilize various third-party services and/or applications for catering, decorating, transportation, entertainment, lodging, and the like. According to conventional techniques, when the event organizer creates the event within the calendar application, the event organizer may associate links to third-party websites and/or applications with the event within the calendar application. However, to actually access such third-party resources, the event organizer and individual event attendees must follow the links to the websites and/or applications and, thus, navigate away from the event view provided by the calendar application. Accordingly, the utilization of such third-party resources occurs outside the context of the calendar application and is not integrated into the event information within the calendar application in any meaningful way. This, in turn, places an additional burden on event organizers and event attendees since they are forced to separately manage and/or interact with all the third-party resources associated with the event.

Furthermore, according to current techniques, event attendees are generally limited in their interaction with the third-party resources. Specifically, due to the technical constraints imposed by current techniques, the scope of interaction between the event attendees and the third-party resources may be specifically defined by the event organizer such that the event attendees' choices with respect to the third-party resources are restricted. As a result, the event attendees' experience with respect to the event may be negatively impacted when the available third-party resource options do not adequately meet their needs and/or desires.

The present techniques solve this issue by providing for the management of third-party resources associated with an event within the context of a calendar application. In other words, the present techniques enable third-party resources to be managed as part of the event functionality provided by the calendar application, without separately navigating to the websites and/or applications associated with such third-party resources. According to embodiments described herein, this is accomplished via an event user interface (UI) that is provided by the calendar application to enable the user of the corresponding computing system to select a third-party resource and to connect with the third-party resource through an application programming interface (API). The event UI further enables the user to input information for interacting with the third-party resource through the API, as provided within the context of the calendar application. Any information input by the user is then automatically reconciled with the event information within the calendar application such that the third-party resource is directly associated with the event itself. As a result, the user is able to access and utilize the third-party resource within the context of the event view provided by the calendar application without having to separately manage the third-party resource. Accordingly, the present techniques simplify the process of planning and/or attending the event by deeply integrating relevant third-party services and/or applications with the calendar application such that the corresponding third-party resource(s) can be seamlessly managed within the context of the calendar application.

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computing systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, the terms “component,” “system,” “client,” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable storage medium.

Moreover, as used herein, the term “computer-readable storage medium” refers to an article of manufacture. In general, computer-readable storage media are used to host, store and/or reproduce computer-executable instructions and data for later retrieval and/or execution. When the computer-executable instructions that are hosted or stored on the computer-readable storage media are executed by a processor of a computing system, the execution thereof causes, configures and/or adapts the executing computing system to carry out various steps, processes, routines, methods and/or functionalities, including the steps, processes, routines, methods, and/or functionalities described herein. Examples of computer-readable storage media include, but are not limited to, optical storage media (such as Blu-ray discs, digital video discs (DVDs), compact discs (CDs), optical disc cartridges, and the like), magnetic storage media (such as hard disk drives, floppy disks, magnetic tape, and the like), memory storage devices (such as random access memory (RAM), read-only memory (ROM), memory cards, thumb drives, and the like), and cloud storage (such as online storage services). Computer-readable storage media may deliver computer-executable instructions to a computing system for execution via various transmission means and mediums, including carrier waves and/or propagated signals. However, for purposes of this disclosure, the term “computer-readable storage medium (or media)” refers specifically to non-transitory forms of computer-readable storage media and expressly excludes carrier waves and/or propagated signals.

### Exemplary Methods for Third-Party Resource Management for Events within Context of Calendar Application

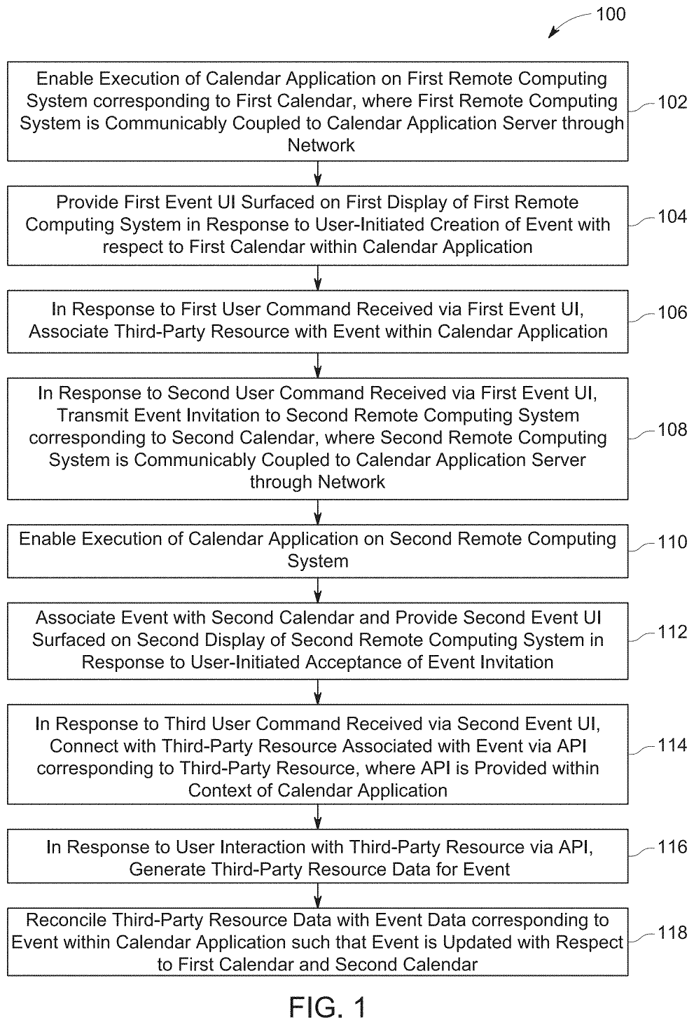

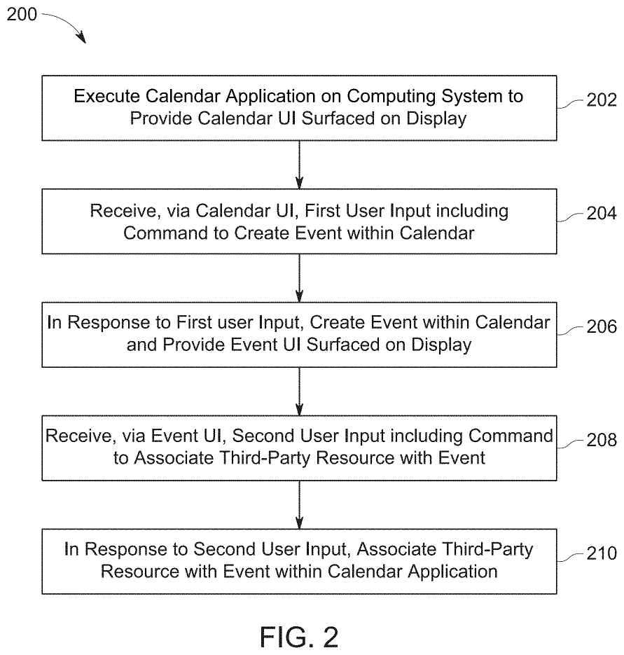

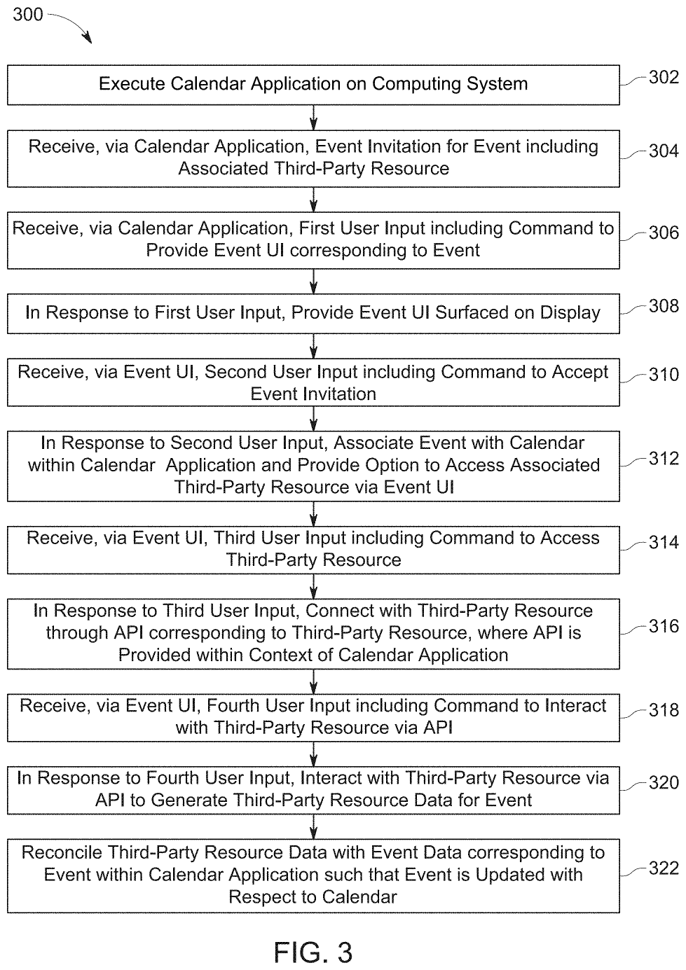

The following is a description of several exemplary methods for implementing the third-party resource management techniques described herein. Specifically, FIG. 1 describes an exemplary method for enabling such third-party resource management techniques from the perspective of a calendar application server providing the calendar application to remote computing systems, which may include, for example, a remote computing system operated by an event organizer and one or more remote computing systems operated by one or more event attendees. FIG. 2 describes an exemplary method for managing one or more third-party resources for an event within the context of the calendar application, where the method may be executed by the remote computing system operated by the event organizer. In addition, FIG. 3 describes an exemplary method for interacting with the one or more third-party resources that have been associated with the event within the context of the calendar application, where the method may be executed any of the remote computing systems operated by the event attendees, as described further herein.

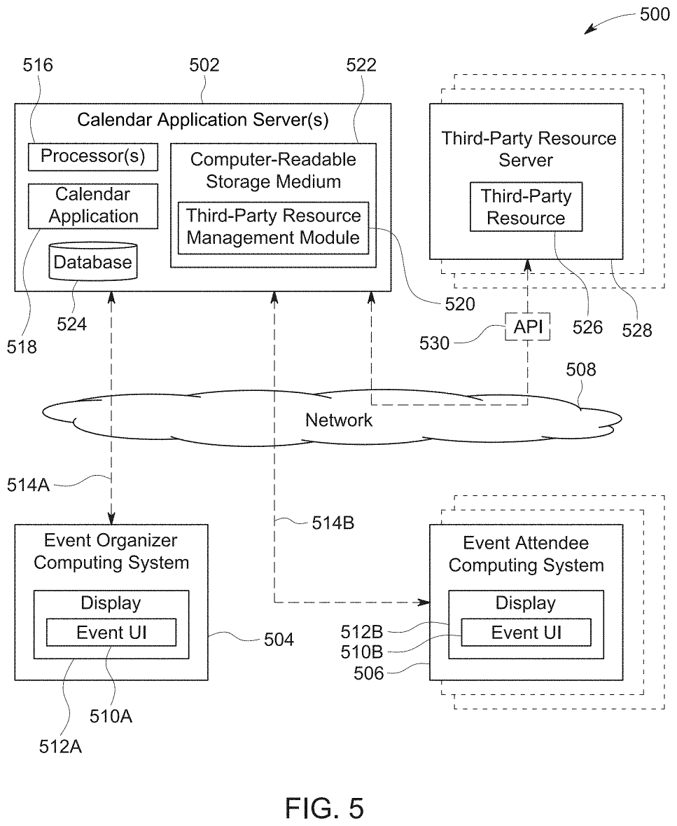

Turning now to the details of the exemplary method figures, FIG. 1 is a process flow diagram of a method 100 for enabling third-party resource management for an event within the context of a calendar application according to embodiments described herein. In various embodiments, the method 100 is executed by a calendar application server, such as the calendar application server described with respect to FIG. 5, where the calendar application server is communicably coupled to two or more remote computing systems via a network. In some embodiments, such remote computing systems include a first remote computing system that is operated by an event organizer (where the term “event organizer” refers to a user who schedules and/or manages an event within the calendar application), a second remote computing system that is operated by an event attendee (where the term “event attendee” refers to a user who is invited to attend the event and consequently accepts the event invitation), and (optionally) any number of additional remote computing systems operated by additional event attendees. Moreover, in various embodiments, the calendar application server includes one or more processors and one or more computer-readable storage media including computer-executable instructions that, when executed by the processor(s), cause the processor(s) to perform the blocks of the method 100.

Turning now to the details of the method 100, the method 100 begins at block 102, at which execution of a calendar application is enabled on a first remote computing system corresponding to a first calendar. According to embodiments described herein, the calendar application may include any application that includes calendar, scheduling, and/or time management functionalities, even if the application also provides other, non-calendar-related functionalities. Non-limiting examples of such calendar applications include the Microsoft Outlook application and the Microsoft Teams application provided by Microsoft Corporation. Moreover, according to the embodiment described with respect to FIG. 1, the calendar application (or at least a portion thereof) is provided by the calendar application server as a web-based application. However, those skilled in the art will appreciate that, in other embodiments, the calendar application (or at least a portion thereof) may be provided as a computer-based application residing on the remote computing systems.

At block 104, a first event user interface is provided surfaced on a first display of the first remote computing system in response to a user-initiated creation of an event with respect to a first calendar within the calendar application. According to embodiments described herein, the term “event” may include any type of meeting, party, appointment, conference, or other scheduling item within a calendar, whether such meeting, party, appointment, conference, or other scheduling item is virtual or in-person. In addition, the term “event user interface” refers to a machine-user interface (such as, for example, a graphical user interface) including an interactive visualization that enables a user of a computing system to visualize and interact with event data corresponding to the event through graphical elements, icons, and the like rendered on the display of the computing system. Moreover, the event user interface described herein includes additional functionalities for enabling the user of the computing system to interact with one or more third-party resources without switching contexts or, in other words, without navigating away from the calendar application, as described further herein. Furthermore, the terms “first” and “second”, when used in reference to the event user interface and other aspects or elements of the techniques described herein, are generally used to describe the event user interface and other aspects/elements from the perspective of different users. For example, the terms “first event user interface” and “second event user interface” are generally used to refer to differing views of the event user interface based on the role of the user operating the computing system. For example, the first event user interface surfaced on the first display of the first computing system may be operated by the event organizer, while the second event user interface surfaced on the second display of the second computing system may be operated by an event attendee. In addition, those skilled in the art will appreciate the event user interface described herein can take various forms depending on the manner in which it is provided. In particular, in some embodiments, the event user interface may be provided by the calendar application within the context of the overall calendar user interface. However, in other embodiments, the event user interface (or some portion thereof) may be provided by the calendar application within the context of a messaging user interface (such as, for example, an email or chat-based messaging user interface, as described further herein).

At block 106, a third-party resource is associated with the event within the calendar application in response to a first user command received via the first event user interface. In various embodiments, the third-party resource includes a third-party service or application offering at least one type of goods (e.g., office equipment, party supplies, food, consumer goods, or the like), a third-party service or application offering at least one type of service (e.g., transportation services, lodging services, entertainment services, cleaning services, or the like), or a third-party service or application offering some combination of goods and services. Moreover, in various embodiments, a number of different third-party resources are associated with the event. As an example, if the event is a work conference, multiple third-party resources may be associated with the work conference to enable the event attendees to, for example, book flights, reserve hotel rooms, and schedule taxi services to and from the event venue.

In various embodiments, associating the third-party resource(s) with the event includes an authorization for one or more event attendees to interact with the third-party resource(s) via the event user interface functionality provided by the calendar application to, for example, select desired goods for the event and/or schedule one or more desired services for the event. Moreover, such an authorization to interact with the third-party resource(s) may include information associated with the event attendees' authorized budget for ordering such goods and/or services. As an example, if the event organizer authorizes the event attendee(s) to interact with a travel application to schedule flights and/or hotels for the event, the event organizer may also include a specific budget for each event attendee during the association of the travel application with the event.

At block 108, an event invitation is transmitted to a second remote computing system corresponding to a second calendar in response to a second user command received via the first event user interface. In various embodiments, the second user command includes an input of the electronic contact information (e.g., email addresses) of the desired event attendee(s) by the event organizer operating the first remote computing system, as well as the sending of the event invitation to such event attendee(s) via electronic means (e.g., via the email or messaging functionality provided by the calendar application itself or another integrated application). Moreover, in various embodiments, the event attendee(s) may receive the event invitation in various forms, such as, for example, as a calendar notification and/or as an email or chat-based message.

At block 110, execution of the calendar application is enabled on the second remote computing system. In some embodiments, the execution of the calendar application is initiated in response to a user input including an opening of the event invitation by the event attendee operating the second remote computing system. For example, if the event attendee receives the event invitation as an email message within their email inbox, the calendar application may be executed in response to the event attendee clicking on a user interface element embedded within the email message.

At block 112, the event is associated with the second calendar and a second event user interface is provided surfaced on a second display of the second remote computing system in response to a user-initiated acceptance of the event invitation. In various embodiments, the user-initiated acceptance of the event invitation is in the form of a user input via a user interface element that indicates an intention to attend the event. Moreover, in various embodiments, the association of the event with the second calendar includes the integration of the event data into the calendar data corresponding to the second calendar, as well as the incorporation of the event into the calendar view that is provided by the calendar user interface.

At block 114, in response to a third user command received via the second event user interface, a connection is established with the third-party resource associated with the event via an application programming interface (API) corresponding to the third-party resource, where the application programming interface is provided within the context of the calendar application. In various embodiments, the third user command includes a user input indicating a desire to access the third-party resource. Such user input may be received in the form of a user selection of (or interaction with) a toggle, button, dropdown menu, or other user interface element provided by the event user interface. Moreover, in response to such user input, the calendar application may automatically establish the connection with the third-party resource via the application programming interface. Specifically, in various embodiments, the application programming interface enables the calendar application server (and/or the remote computing system executing the calendar application) to communicate with the third-party service or application over the network. Furthermore, in various embodiments, the connection with the third-party resource may be visually presented in the form of an overlay of information corresponding to the third-party resource within the event user interface surfaced on the display. Such visually-overlaid information may include, but is not limited to, options for goods and/or services that the third-party service or application is capable of providing for the event.

Moreover, in some embodiments, a connection may be simultaneously established with multiple third-party resources associated with the event via corresponding application programming interfaces corresponding to the third-party resources. In such embodiments, the connection with the third-party resources may be visually presented in the form of an overlay of information corresponding to all the third-party resources within the event user interface surfaced on the display, such that the goods and/or services offered by the different third-party services can be easily viewed and/or compared.

At block 116, third-party resource data are generated for the event in response to user interaction with the third-party resource. In various embodiments, the user interaction with the third-party resource includes a selection of desired goods and/or services for the event. Moreover, the third-party resource data may include data corresponding to the event attendee's selection of such desired goods and/or services, as well as expense information (if any) corresponding to the selection.

At block 118, the third-party resource data are reconciled with event data corresponding to the event within the calendar application such that the event is updated with respect to the first calendar and the second calendar. In various embodiments, the reconciled event data are then provided to the first remote computing system operated by the event organizer such that the third-party resource data generated as a result of the user interaction with the third-party resource is presented via the first event user interface surfaced on the first display. In addition, in such embodiments, an expense report may be provided to the first remote computing system corresponding to the first calendar. The expense report may include any expenses associated with the user interaction with the third-party resource(s) via the second remote computing system corresponding to the second calendar. For example, the expense report may include the cost of the goods and/or services selected by the event attendee operating the second remote computing system.

In some embodiments, this expense report functionality may be provided by the calendar application itself. However, in other embodiments, the expense report functionality may be provided by another third-party resource. In such embodiments, the calendar application may enable the third-party resource providing the expense report functionality to access the reconciled event data including the third-party resource data to extract the information needed for generating the expense report.

Moreover, in various embodiments, the calendar application may enable any number of other third-party resources to access the reconciled event data (or some portion thereof) to coordinate other tasks or to provide other goods/services for the event. As an example, if the reconciled event data includes information regarding food that is being provided for the event, the calendar application may enable a third-party resource offering beverages to view the reconciled event data including the food information to determine suitable beverages for the event. As another example, if the reconciled event data includes information regarding decorations and/or other supplies that are being provided for the event, the calendar application may enable a third-party resource offering event setup/teardown services to view the reconciled event data including the decoration/supplies information to plan the event setup and/or teardown before the event.

Furthermore, those skilled in the art will appreciate that, in some embodiments, blocks 108-116 may be provided for one or more additional remote computing systems, particularly for embodiments in which the event invitation is sent to more than one event attendee. Therefore, in such embodiments, the corresponding third-party resource data received from the second remote computing system and the additional remote computing system(s) may be reconciled with the event data corresponding to the event within the calendar application. The reconciled event data may then be provided to the first remote computing system such that the third-party resource data generated as a result of the user interactions with the third-party resource(s) are presented via the first event user interface surfaced on the first display. In various embodiments, this enables the event organizer operating the first remote computing system to easily manage all the goods and/or services associated with the event from the event user interface provided by the calendar application, as well as to easily manage the expense associated with the goods and/or services. As an example, if the event is a virtual team meeting early in the morning, the event organizer may utilize the event user interface provided by the calendar application to enable each event attendee to spend a specified amount of money ordering their preferred coffee beverage from a particular coffee shop (or from their own preferred or local coffee shop), and the event organizer may then receive a consolidated expense report including the costs associated with the event.

The block diagram of FIG. 1 is not intended to indicate that the blocks of the method 100 are to be executed in any particular order, or that all of the blocks of the method 100 are to be included in every case. Moreover, any number of additional blocks may be included within the method 100, depending on the details of the specific implementation. For example, in some embodiments, the method 100 also includes enabling the event organizer operating the first remote computing system to directly interact with the third-party resource associated with the event. In such embodiments, the method 100 may include connecting with the third-party resource associated with the event via the application programming interface corresponding to the third-party resource in response to a fourth user command received via the first event user interface surfaced on the first display of the first remote computing system. In such embodiments, the method 100 may also include generating additional third-party resource data for the event in response to a second user interaction with the third-party resource via the application programming interface, as well as reconciling the additional third-party resource data with the event data corresponding to the event within the calendar application such that the event is further updated with respect to the first calendar and the second calendar. As an example of such embodiments, if the event is a work conference, the event organizer may utilize the event user interface to schedule his own roundtrip flight to and from the conference, in addition to enabling his team members to book their own roundtrip flights.

Furthermore, in some embodiments, the term “event” may encompass multiple events that are linked together within the calendar application. For example, if an event organizer is planning multiple, back-to-back meetings with the same event attendees, the event organizer may want to associate one or more third-party resources with both meetings such that the event attendees have a specified budget for ordering goods and/or services for both meetings. Accordingly, the event user interface may include a linking option by which the event organizer can provide input (e.g., via a toggle, toggle, button, dropdown menu, or other user interface element) indicating an intention to link the two meetings together such that they are treated as one event with respect to the third-party resource management techniques described herein.

In addition, while the third-party resource management techniques provided herein are primarily described with reference to managing third-party resources for newly-created events, those skilled in the art will appreciate that such techniques can be easily extended to managing third-party resources for existing events. In particular, the techniques described herein may enable the user to associate third-party resources with an event at any time before the occurrence of the event.

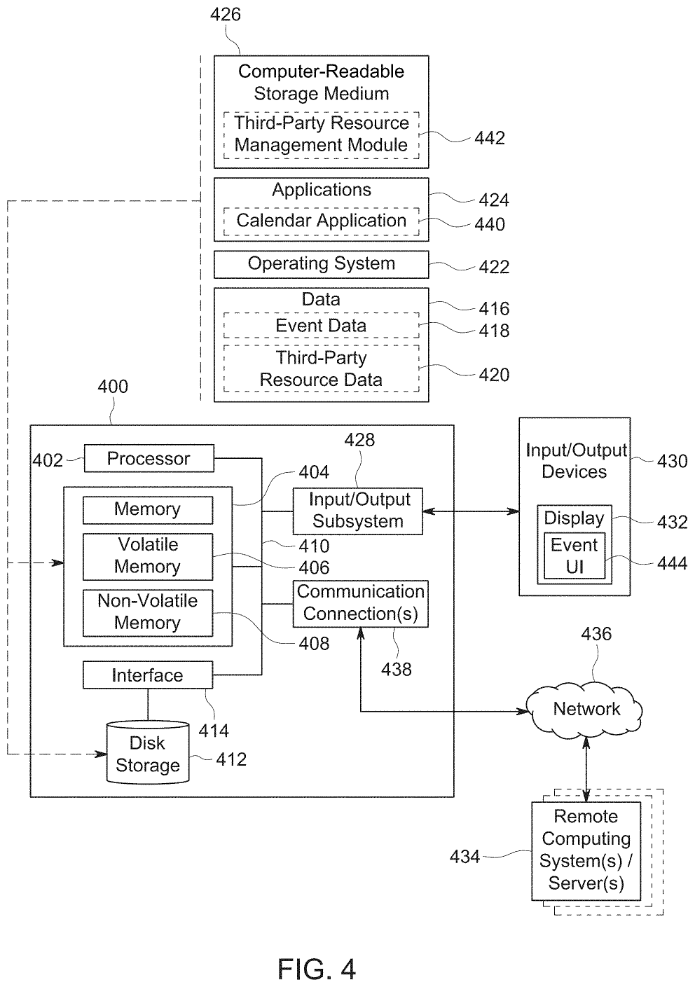

FIG. 2 is a process flow diagram of a method 200 for managing a third-party resource for an event within the context of a calendar application according to embodiments described herein. The method 200 is executed via a computing system including a processor and a display operatively coupled to each other, such as, for example, the computing system described with respect to FIG. 4, where the computing system may be operated by the event organizer. Moreover, in various embodiments, the method 200 of FIG. 2 is similar to the method 100 of FIG. 1. However, the method 200 is implemented from the perspective of the computing system being operated by the event organizer (or other user who is managing the event), rather than from the perspective of the calendar application server. Furthermore, according to the embodiment described with respect to FIG. 2, the calendar application (or at least a portion thereof) may be a computer-based application residing within the memory and/or storage of the computing system.

The method 200 begins at block 202, at which a calendar application is executed on the computing system to provide a calendar user interface surfaced on the display. At block 204, a first user input including a command to create an event within a calendar is received via the calendar user interface. At block 206, the event is created within the calendar and an event user interface is provided surfaced on the display in response to the first user input.

At block 208, a second user input including a command to associate a third-party resource with the event is received via the event user interface. In addition, at block 210, the third-party resource is associated with the event within the calendar application in response to the second user input.

The block diagram of FIG. 2 is not intended to indicate that the blocks of the method 200 are to be executed in any particular order, or that all of the blocks of the method 200 are to be included in every case. Moreover, any number of additional blocks may be included within the method 200, depending on the details of the specific implementation. For example, in some embodiments, the method 200 also includes receiving a third user input including a command to transmit an event invitation for the event to one or more desired event attendees, as well as transmitting the event invitation to one or more remote computing systems corresponding to the one or more event attendees via the network.

FIG. 3 is a process flow diagram of a method for interacting with a third-party resource associated with an event within the context of a calendar application according to embodiments described herein. The method 300 is executed via a computing system including a processor and a display operatively coupled to each other, such as, for example, the computing system described with respect to FIG. 4, where the computing system may be operated by an event attendee.

The method 300 begins at block 302, at which the calendar application is executed on the computing system. At block 304, an event invitation for an event including an associated third-party resource is received via the calendar application. At block 306, a first user input including a command to provide an event user interface corresponding to the event is received via the calendar application. Moreover, at block 308, the event user interface is provided surfaced on the display in response to the first user input.

At block 310, a second user input including a command to accept the event invitation is received via the event user interface. At block 312, the event is associated with a calendar within the calendar application and an option to access the associated third-party resource is provided via the event user interface in response to the second user input. At block 314, a third user input including a command to access the third-party resource is received via the event user interface. Moreover, at block 316, a connection is established with the third-party resource through an application programming interface corresponding to the third-party resource in response to the third user input, where the application programming interface is provided within the context of the calendar application.

The method 300 then proceeds to block 318, at which a fourth user input including a command to interact with the third-party resource via the application programming interface is received via the event user interface. At block 320, an interaction with the third-party resource is carried out via the application programming interface in response to the fourth user input, resulting in the generation of third-party resource data for the event. At block 322, the third-party resource data are reconciled with event data corresponding to the event within the calendar application such that the event is updated with respect to the calendar.

The block diagram of FIG. 3 is not intended to indicate that the blocks of the method 300 are to be executed in any particular order, or that all of the blocks of the method 300 are to be included in every case. Moreover, any number of additional blocks may be included within the method 300, depending on the details of the specific implementation. For example, in some embodiments, the method 100 also includes receiving, via the calendar application, one or more reminders to access the third-party resource prior to the event. In such embodiments, the reminder(s) may be provided in the form of calendar notifications and/or email or chat-based messages. As an example, such reminders may be sent 48 hours and/or 24 hours before the scheduled time for the event.

### Exemplary Computing System and Network Environment for Implementing Third-Party Resource Management Techniques Described Herein

FIG. 4 is a block diagram of an exemplary computing system 400 for implementing the third-party resource management techniques described herein. In various embodiments, the computing system 400 is operated by a user, where such user may be an event organizer or an event attendee, as described herein. The exemplary computing system 400 includes a processor 402 and a memory 404. The processor 402 may include any suitable type of processing unit or device, such as, for example, a single-core processor, a multi-core processor, a computing cluster, or any number of other configurations. Moreover, the processor 402 may include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combinations thereof, designed to perform the functions described herein.

The memory 404 typically (but not always) includes both volatile memory 406 and non-volatile memory 408. The volatile memory 406 retains or stores information so long as the memory is supplied with power. By contrast, the non-volatile memory 408 is capable of storing (or persisting) information even when a power supply is not available. The volatile memory 406 may include, for example, RAM (e.g., synchronous RAM (SRAM), dynamic RAM (DRAM), synchronous dynamic RAM (SDRAM), and the like) and CPU cache memory. The nonvolatile memory 408 may include, for example, read-only memory (ROM) (e.g., programmable ROM (PROM), electrically programmable ROM (EPROM), electrically erasable ROM (EEROM) or the like), flash memory, nonvolatile random-access memory (RAM), solid-state memory devices, memory storage devices, and/or memory cards.

The processor 402 and the memory 404, as well as other components of the computing system 400, are interconnected by way of a system bus 410. The system bus 410 can be implemented using any suitable bus architecture known to those skilled in the art.

According to the embodiment shown in FIG. 4, the computing system 400 also includes a disk storage 412. The disk storage 412 may include any suitable removable/non-removable, volatile/non-volatile storage component or device. For example, the disk storage 412 may include, but is not limited to, a magnetic disk drive, floppy disk drive, tape drive, Jaz drive, Zip drive, LS-210 drive, flash memory card, memory stick, or the like. In addition, the disk storage 412 may include storage media separately from (or in combination with) other storage media including, but not limited to, an optical disk drive, such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 412 to the system bus 410, a removable or non-removable interface is typically used, such as interface 414 shown in FIG. 4.

In various embodiments, the disk storage 412 and/or the memory 404 are used to store data 416 relating to the techniques described herein. Such data may include, for example, event data 418 relating to one or more events scheduled with respect to a calendar application, as well as third-party resource data 420 that are associated with the one or more events and may be reconciled with the event data, as described herein.

Those skilled in the art will appreciate that FIG. 4 describes software that acts as an intermediary between a user of the computing system 400 and the basic computing resources described with respect to the operating environment of the computing system 400. Such software includes an operating system 422. The operating system 422, which may be stored on the disk storage 412, acts to control and allocate the computing resources of the computing system 400. Moreover, system applications 424 take advantage of the management of the computing resources by the operating system 422 through one or more program modules stored within a computer-readable storage medium (or media) 426, as described further herein.

The computing system 400 also includes an input/output (I/O) subsystem 428. The I/O subsystem 428 includes a set of hardware, software, and/or firmware components that enable or facilitate inter-communication between the user of the computing system 400 and the processor 402 of the computing system 400. During operation of the computing system 400, the I/O subsystem 428 enables the user to interact with the computing system 400 through various input/output (I/O) devices 430. Such I/O devices 430 may include any number of input devices or channels, such as, for example, one or more touchscreen/haptic input devices, one or more buttons, one or more pointing devices, one or more accessories, one or more audio input devices, and/or one or more video input devices, such as a camera. As an example, in some embodiments, such input devices or channels include one or more Natural User Interface (NUI) devices, where the term “Natural User Interface (NUI)” refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch-sensitive displays, voice and speech recognition, intention and goal understanding, and motion gesture detection using depth cameras such as stereoscopic camera systems, infrared camera systems, RGB camera systems, and combinations of these. NUI devices can also include motion gesture detection using accelerometers or gyroscopes, facial recognition, three-dimensional (3D) displays, head, eye, and gaze tracking, immersive augmented-reality and virtual-reality systems, all of which provide a more natural interface. Furthermore, in some embodiments the one or more input devices or channels connect to the processor 402 through the system bus 410 via one or more interface ports (not shown) integrated within the I/O subsystem 428. Such interface ports may include, for example, a serial port, a parallel port, a game port, and/or a universal serial bus (USB).

In addition, such I/O devices 430 may include any number of output devices or channels, such as, for example, one or more audio output devices, one or more haptic feedback devices, and/or one or more display devices, such as display 432. Such output devices or channels may use some of the same types of ports as the input devices or channels. Thus, for example, a USB port may be used to both provide input to the computing system 400 and to output information from the computing system 400 to a corresponding output device. Moreover, in some embodiments, the one or more output devices or channels are accessible via one or more adapters (not shown) integrated within the I/O subsystem 428.

In some embodiments, the display 432 is a built-in display screen of the computing system 400. In other embodiments, the display 432 is an external display screen. Moreover, in various embodiments, the display 432 is a touchscreen that serves as both an input and an output device.

In various embodiments, the computing system 400 is communicably coupled to one or more remote computing systems 434. As an example, for embodiments in which the computing system 400 is operated by an event organizer, the remote computing system(s) 434 may be operated by corresponding event attendee(s). As another example, for embodiments in which the computing system 400 is operated by an event attendee, the remote computing system(s) 434 may be operated by a corresponding event organizer and (optionally) one or more additional event attendees.

As another example, in some embodiments, the computing system 400 (or a portion thereof) is a server hosting various software applications in a networked environment using logical connections to the remote computing systems 434. In such embodiments, any number of the components shown in FIG. 4 (such as, for example, the computer-readable storage medium 426 including the third-party resource management module, the calendar application, and at least a portion of the data) may be hosted on the server, while any number of the other components shown in FIG. 4 (such as, for example, the display 432 surfacing the event user interface) may be implemented with respect to one or more of the remote computing systems 434, which may be operated by the end users of the calendar application. Such embodiments are described further with respect to the exemplary network environment 500 of FIG. 5.

The one or more remote computing systems 434 may be, for example, client systems configured with web browsers, PC applications, mobile phone applications, and the like. In addition, the remote computing systems 434 may include, for example, one or more personal computers, one or more servers, one or more routers, one or more network PCs, one or more workstations, one or more microprocessor-based appliances, one or more mobile phones, and/or one or more peer devices or other common network nodes.

In various embodiments, the remote computing devices 434 are logically connected to the computing system 400 through a network 436 and then connected via a communication connection 438, which may be wireless. The network 436 encompasses wireless communication networks, such as local-area networks (LAN) and wide-area networks (WAN). LAN technologies include Fiber Distributed Data Interface (FDDI), Copper Distributed Data Interface (CDDI), Ethernet, Token Ring, and the like. WAN technologies include, but are not limited to, point-to-point links, circuit switching networks like Integrated Services Digital Networks (ISDN) and variations thereon, packet switching networks, and Digital Subscriber Lines (DSL).

The communication connection 438 includes the hardware/software employed to connect the network 436 to the bus 410. While communication connection 438 is shown for illustrative clarity as residing inside the computing system 400, it can also be external to the computing system 400. The hardware/software for connection to the network 436 may include, for example, internal and external technologies, such as mobile phone switches, modems including regular telephone grade modems, cable modems and DSL modems, ISDN adapters, and/or Ethernet cards.

As described above, system applications 424, such as the calendar application 440 described herein, take advantage of the management of the computing resources by the operating system 422 through one or more program modules stored within the computer-readable storage medium (or media) 426. In some embodiments, the computer-readable storage medium 426 is integral to the computing system 400, in which case it may form part of the memory 404 and/or the disk storage 412. In other embodiments, the computer-readable storage medium 426 is an external device that is connected to the computing system 400 when in use.

In various embodiments, the one or more program modules stored within the computer-readable storage medium 426 include program instructions or code that may be executed by the processor 402 to perform various operations, including the third-party resource management techniques described herein. In various embodiments, such program modules include, but are not limited to, a third-party resource management module 442 that causes the processor 402 to perform operations that result in the execution of the techniques described herein for managing third-party resources for events within the context of the calendar application 440, as described herein with respect to the methods 100, 200, and 300 of FIGS. 1, 2, and 3, respectively.

Furthermore, as shown in FIG. 4, execution of the calendar application 440 in conjunction with the third-party resource management module 442 results in the surfacing of an event user interface (UI) 444 on the display 432 of the computing system 400. As described herein, the surfaced event user interface 444 includes a machine-user interface (such as, for example, a graphical user interface) including an interactive visualization that enables the user of the computing system 400 (e.g., the event organizer or event attendee) to visualize and interact with the event data 418 corresponding to an event scheduled with respect to the calendar application 440 through graphical elements, icons, and the like rendered on the display 432. Moreover, as also described herein, the event user interface 444 includes additional functionalities that enable the user of the computing system 400 to interact with one or more third-party resources without switching contexts or, in other words, without closing or navigating away from the calendar application 440. This results in the generation of the third-party resource data 420, which are reconciled with the event data 418 to enable the user to seamlessly manage the third-party resource(s) associated with the event from the event user interface 444 provided by the calendar application 440.

It is to be understood that the block diagram of FIG. 4 is not intended to indicate that the computing system 400 is to include all of the components shown in FIG. 4. Rather, the computing system 400 can include fewer or additional components not illustrated in FIG. 4 (e.g., additional applications, additional modules, additional memory devices, additional network interfaces, etc.). Furthermore, any of the functionalities of the one or more program modules/sub-modules may be partially, or entirely, implemented in hardware and/or in the processor 402. For example, the functionality may be implemented with an application specific integrated circuit, in logic implemented in the processor 402, or in any other device.

FIG. 5 is a block diagram of an exemplary network environment 500 for implementing the third-party resource management techniques described herein. As shown in FIG. 5, the network environment 500 includes a calendar application server 502 that provides calendar, scheduling, and/or time management functionalities to various remote computing systems. As described with reference to a single event within the calendar application, such remote computing systems may include, for example, an event organizer computing system 504 and one or more event attendee computing systems 506. Moreover, the calendar, scheduling, and/or time management functionalities may be provided to the event organizer computing system 504 and the event attendee computing system(s) 506 via a network 508, which provides a communications link for facilitating the transfer of electronic content between the calendar application server 502 and the remote computing systems 504 and 506. The network 508 may include, but is not limited to, a cellular network, a point-to-point dial up connection, a satellite network, the Internet, a local area network (LAN), a wide area network (WAN), and/or a Wi-Fi network. Such networks are widely used to connect various types of network elements, such as routers, servers, and gateways. Moreover, those skilled in the art will appreciate that the present techniques may also be practiced in a multi-network environment having various connected public and/or private networks. Furthermore, those skilled in the art will appreciate that communication networks can take several different forms and use several different communication protocols. For example, in some embodiments, the present techniques may be practiced in a distributed computing environment in which tasks are performed by remote processing devices that are linked through a communications network. In a distributed computing environment, program modules can be located in both local and remote computer-readable storage media.

In various embodiments, the event organizer computing system 504 and the event attendee computing systems 506 each include a processor, memory, disk storage, and input/output subsystem that operatively couple one or more input/output devices to the processor, as described with respect to the computing system 400 of FIG. 4. Moreover, each remote computing system 504 and 506 may include any suitable type of computing device, including, but not limited to, a desktop computer, laptop computer, tablet, mobile phone, gaming system, television, or the like. Generally speaking, each remote computing system 504 and 506 may include any type of computing device that provides its user with the ability to load and execute software programs, as well as the ability to access the network 508 to communicate with the calendar application server 502.

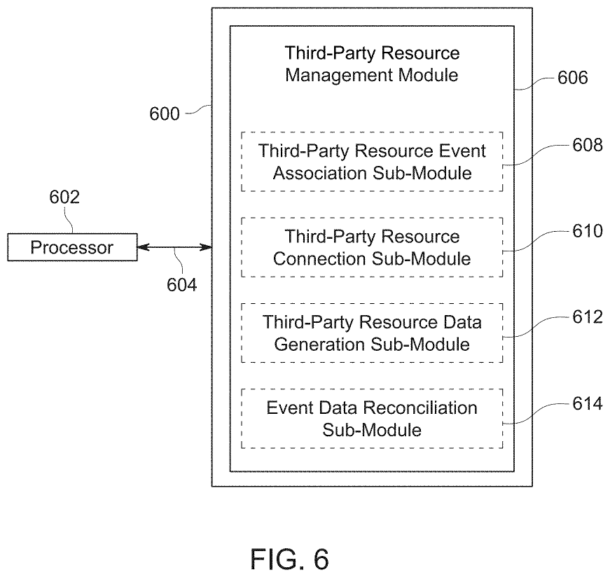

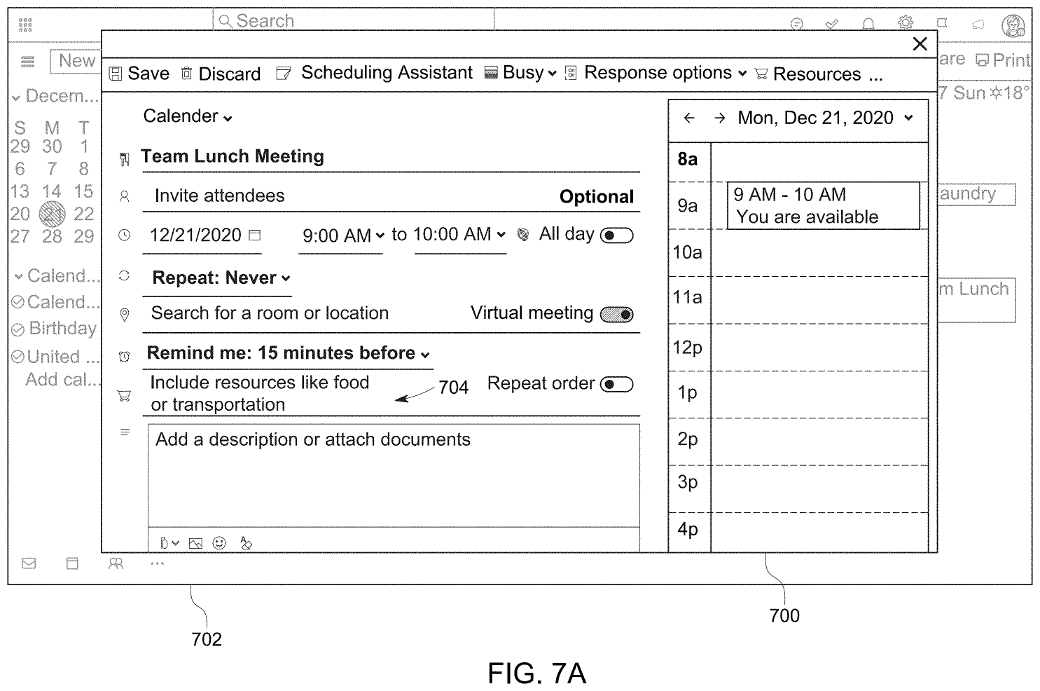

In various embodiments, the calendar application server 502 hosts an event user interface 510A and 5108 on a display 512A and 5128 of each remote computing system 504 and 506, as indicated by arrow 514A and 514B, respectively. In various embodiments, this is accomplished by executing, via a processor 516 of the calendar application server 502, a calendar application 518 in conjunction with a third-party resource management module 520 stored within a computer-readable storage medium 522 of the calendar application server 502, as described further with respect to FIG. 6. In addition, the calendar application server 502 may include a database 524 that functions as a repository for the data used by the components of the calendar application server 502 to enable execution of the calendar application 518 on the remote computing systems 504 and 506. In various embodiments, such data include at least a portion of the event data and the third-party resource data described herein.

In various embodiments, the calendar application server 502 further enables one or more third-party resources 526 (e.g., one or more third-party services or applications providing particular types of goods and/or services) to be associated with events within the calendar application 518. For example, the calendar application server 502 may associate the event corresponding to the event user interface 510A with the third-party resource(s) 526 corresponding to third-party resource server(s) 528, for example, in response to one or more user inputs or commands received via the event user interface 510A surfaced on the display 512A of the event organizer computing system 504. In addition, the calendar application 502 may connect with each third-party resource 526 via a corresponding application programming interface (API) 530 in response to a user input or command received via the event user interface 5108 surfaced on the display 5128 of the event attendee computing system 506. Furthermore, the calendar application 502 may then interact with the third-party resource(s) 526 via the corresponding application programming interface(s) 530 in response to additional user inputs or commands received via the event user interface 5108, where such user inputs or commands may relate to, for example, the purchase of goods and/or services from the third-party resource(s) 526.

It is to be understood that the block diagram of FIG. 5 is not intended to indicate that the network environment 500 is to include all of the components shown in FIG. 5. Rather, the network environment 500 can include fewer or additional components not illustrated in FIG. 5. For example, in practice, the calendar application server 502 and the remote computing systems 504 and 506 will include a number of additional components not depicted in the simplified block diagram of FIG. 5, as described with respect to the computing system 400 of FIG. 4, for example.

FIG. 6 is a block diagram of an exemplary computer-readable storage medium 600 for implementing the third-party resource management techniques described herein. In various embodiments, the computer-readable storage medium 600 is accessed by a processor 602 over a computer interconnect 604. For example, in some embodiments, the computer-readable storage medium 600 is the same as, or similar to, the computer-readable storage medium described with respect to the computing system 400 of FIG. 4 and/or the network environment 500 of FIG. 5.

In various embodiments, the computer-readable storage medium 600 includes code (i.e., computer-executable instructions) to direct the processor 602 to perform the operations of the present techniques. Such code may be stored within the computer-readable storage medium 600 in the form of program modules, where each module includes a set of computer-executable instructions that, when executed by the processor 602, cause the processor 602 to perform a corresponding set of operations. In particular, in various embodiments, the computer-readable storage medium 600 includes a third-party resource management module 606 that directs the processor 602 to perform the techniques described herein (or any suitable variation thereof). Such techniques include, but are not limited to, the methods 100, 200, and 300 described with respect to FIGS. 1, 2, and 3, respectively.

Furthermore, in various embodiments, the third-party resource management module 606 accomplishes this via a number of sub-modules. Such sub-modules may include, but are not limited to, a third-party resource event association sub-module 608 for associating a third-party resource with an event within a calendar application in response to a user command received via an event user interface functionality provided by the calendar application, a third-party resource connection sub-module 610 for connecting with the third-party resource via an application programming interface corresponding to the third-party resource in response to another user command received via the event user interface functionality provided by the calendar application (where the application programming interface is provided within the context of the calendar application), a third-party resource data generation sub-module 612 for generating third-party resource data for the event in response to user interaction with the third-party resource via the application programming interface provided within the context of the calendar application, and an event data reconciliation sub-module 614 for reconciling the generated third-party resource data with event data corresponding to the event within the calendar application.

Moreover, those skilled in the art will appreciate that any suitable number of the modules/sub-modules shown in FIG. 6 may be included within the computer-readable storage medium 600. Furthermore, any number of additional modules/sub-modules not shown in FIG. 6 may be included within the computer-readable storage medium 600, depending on the details of the specific implementation.

### Exemplary Embodiments of Third-Party Resource Management Techniques Described Herein

The following is a description of several exemplary implementations of the third-party resource management techniques described herein for particular use-case scenarios. Those skilled in the art will appreciate that such exemplary implementations are for illustrative purposes only. In practice, the third-party resource management techniques described herein may be implemented in any other suitable manner to achieve any other suitable results, depending on the details of the particular implementation.

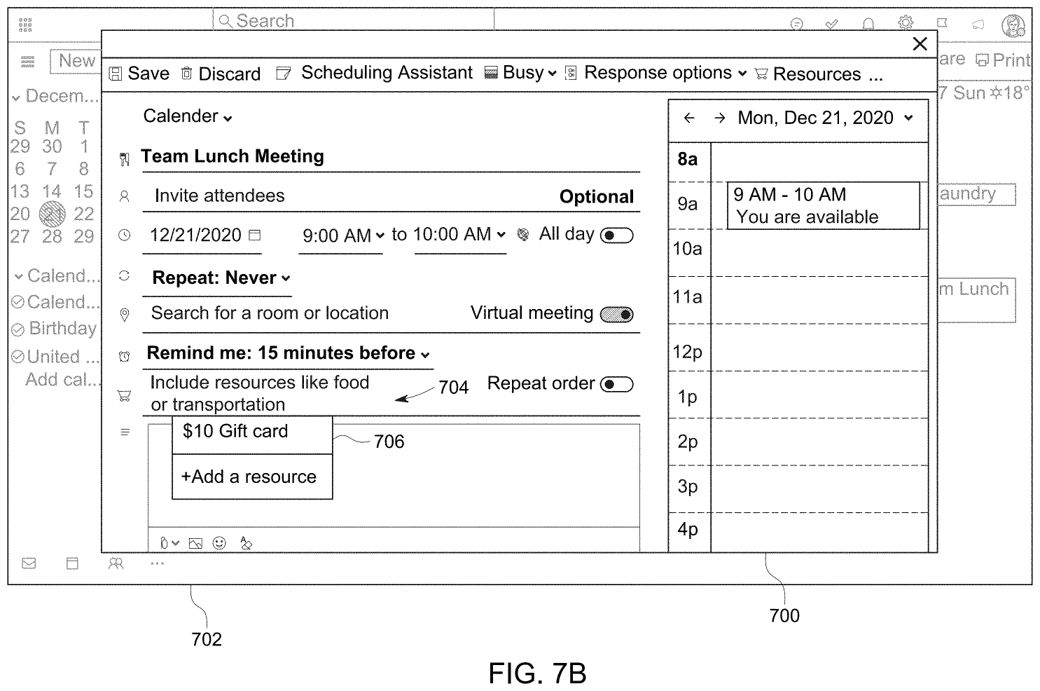

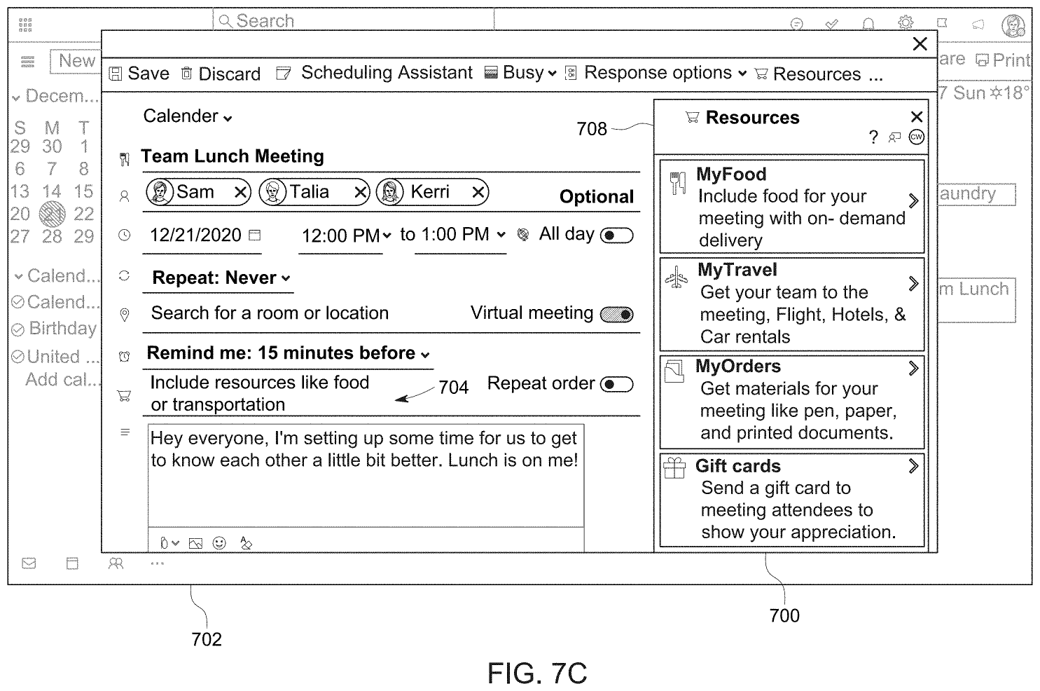

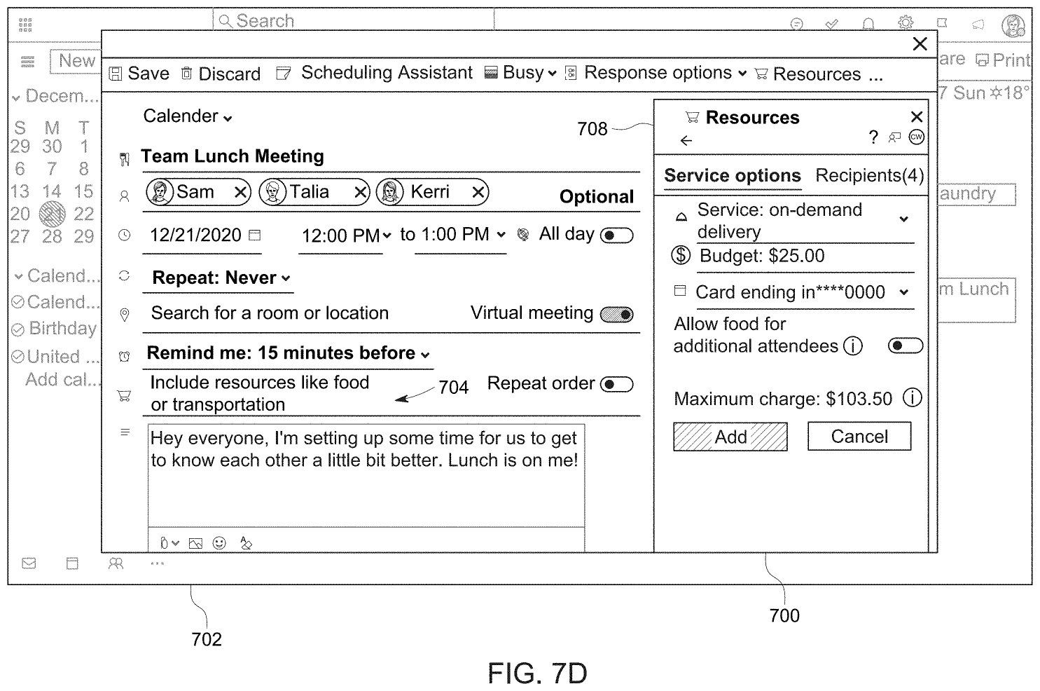

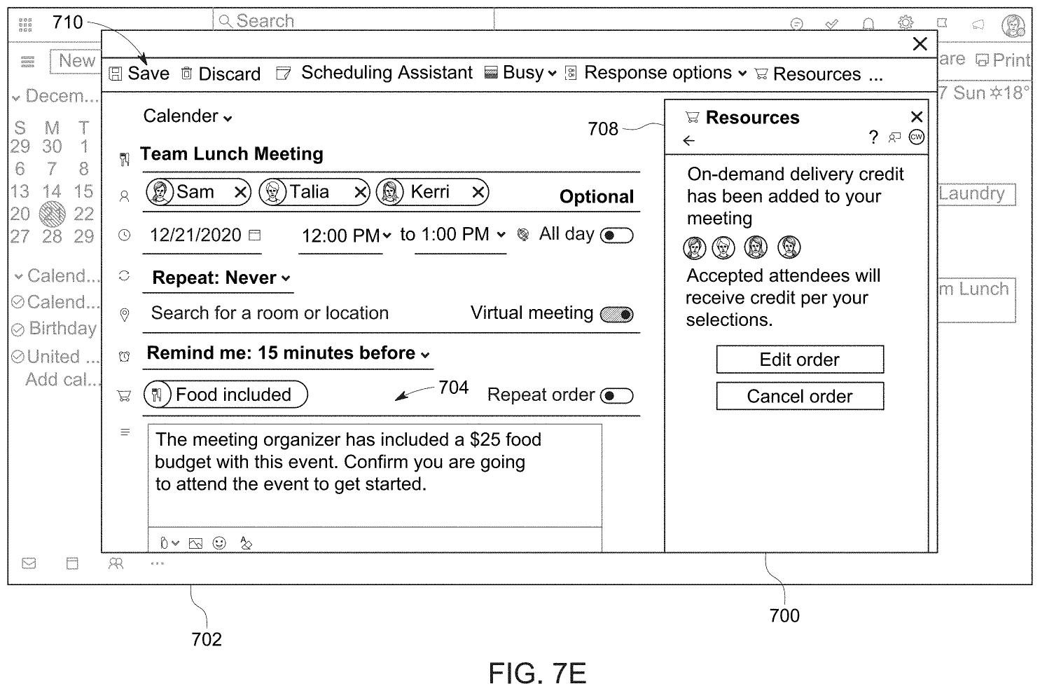

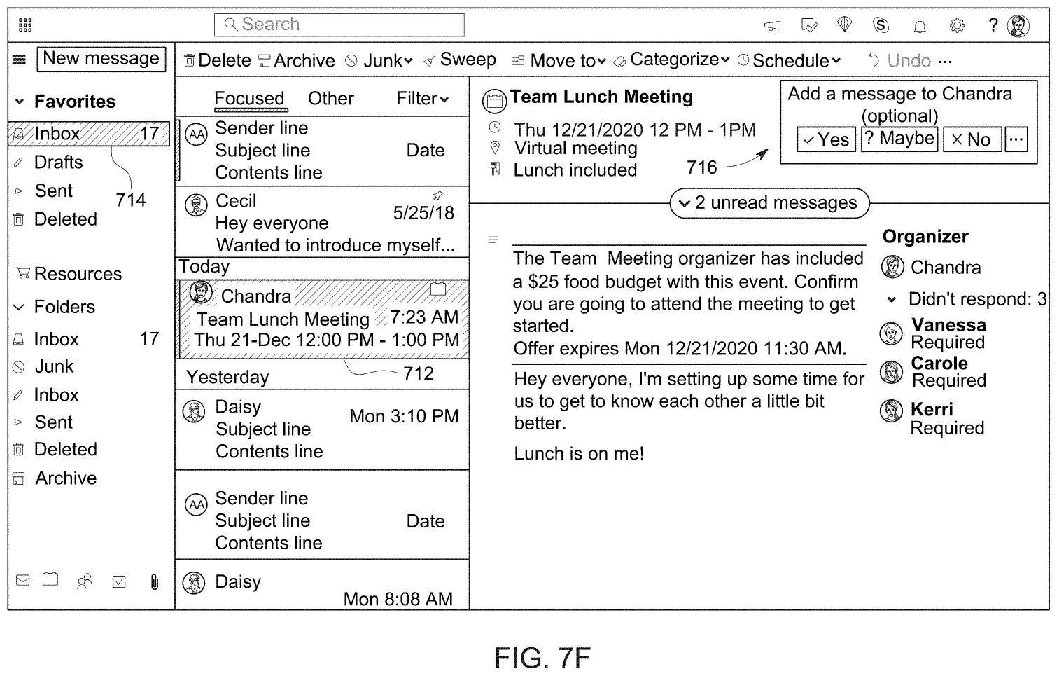

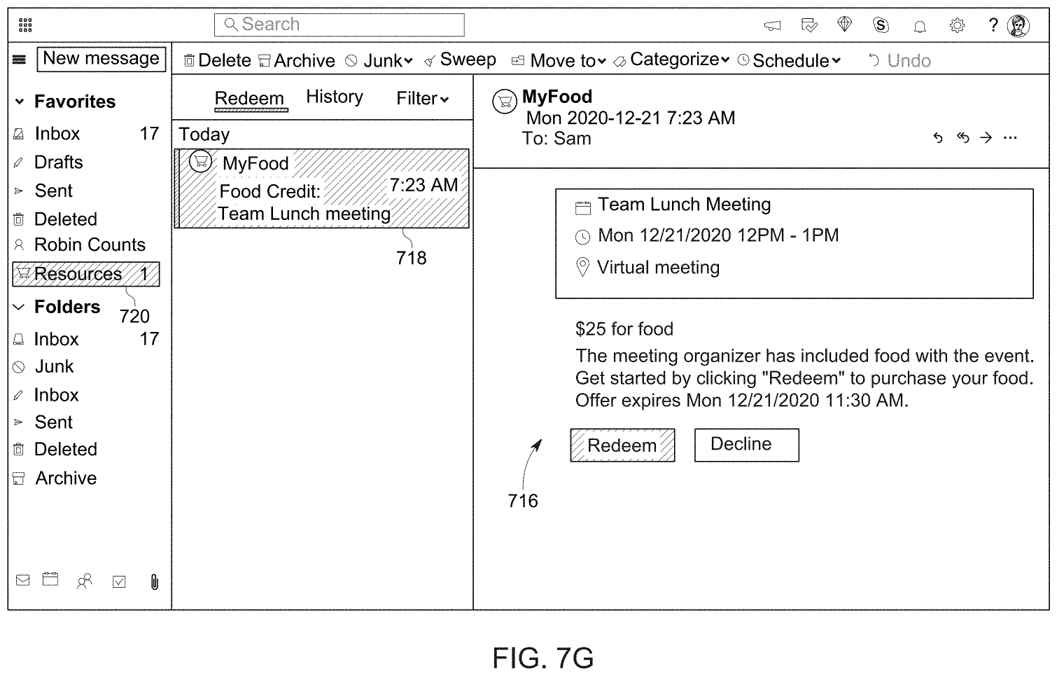

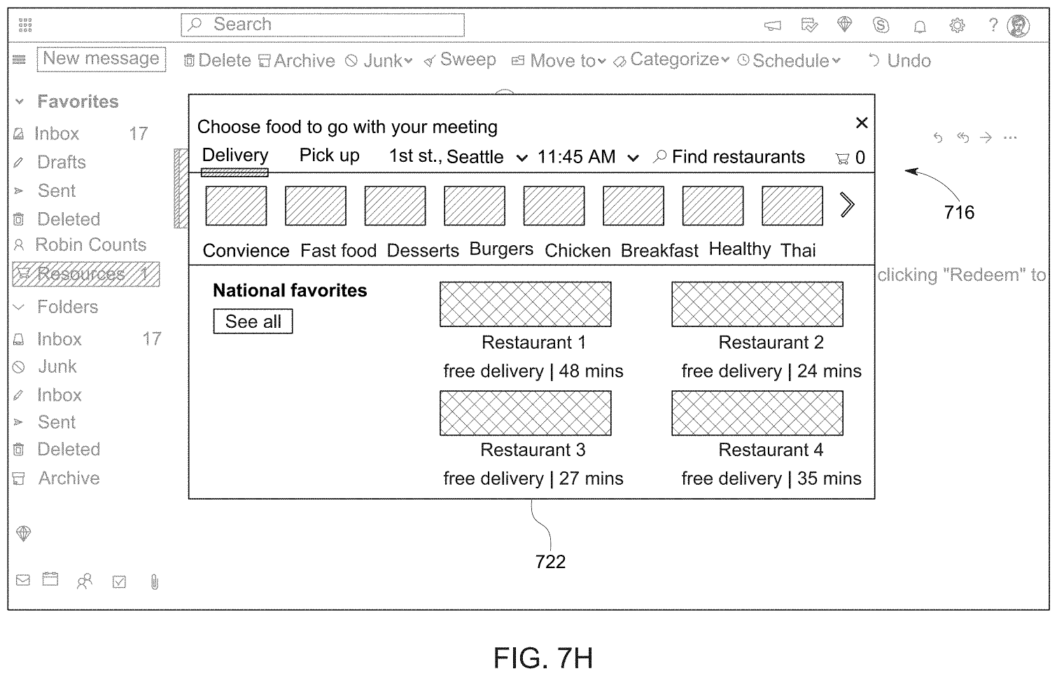

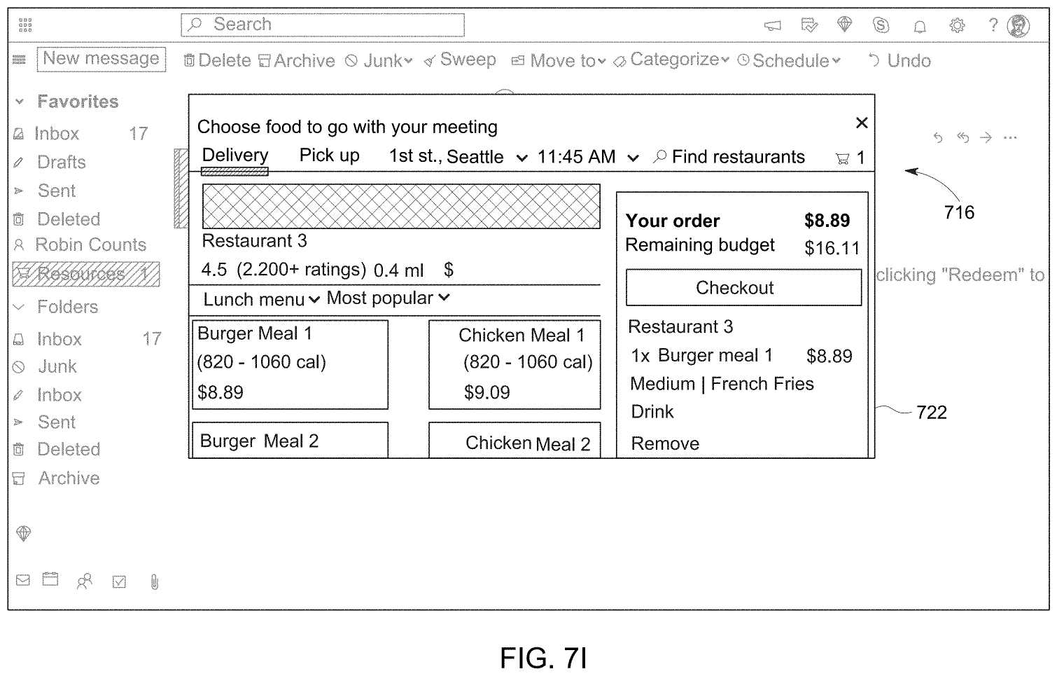

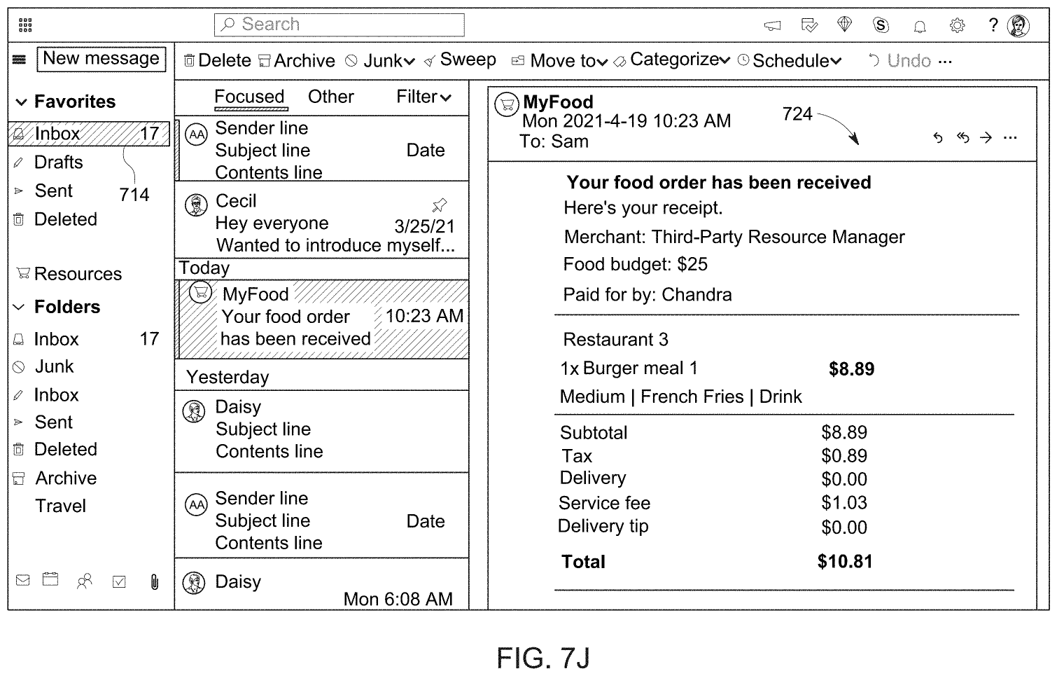

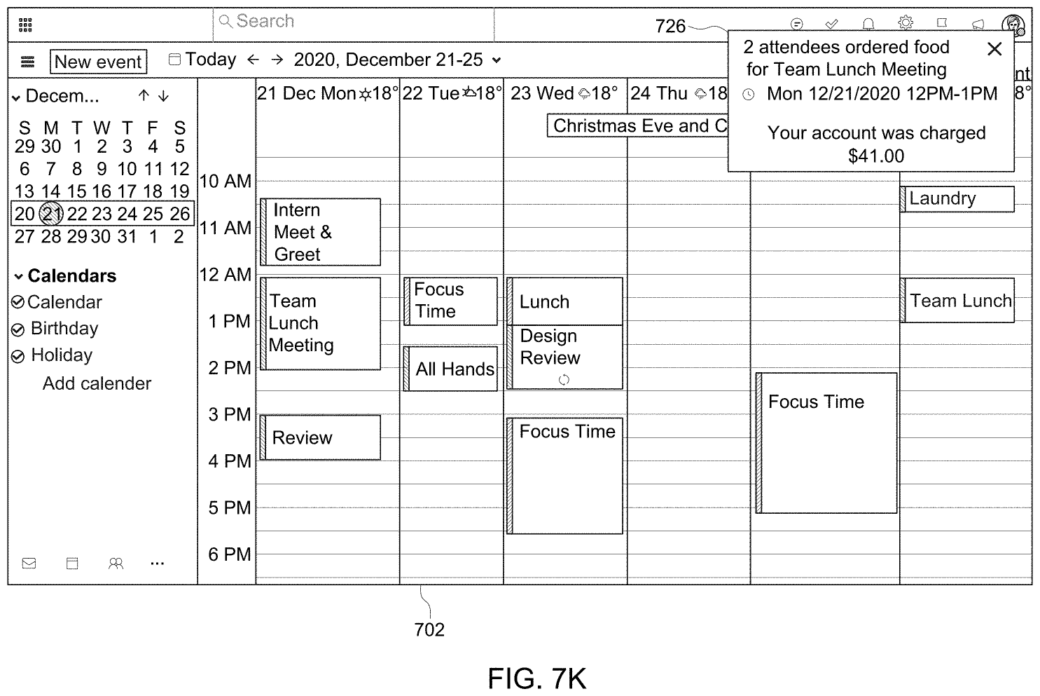

Turning now to the details of the first exemplary implementation, FIGS. 7A-K depict the manner in which the third-party resource management techniques described herein can be used to order goods, such as, for example, food, for an event. Specifically, FIG. 7A is a schematic view of a first event user interface 700 that is overlaid on top of a first calendar user interface 702 within the context of a calendar application, as viewed from the perspective of the event organizer. In various embodiments, the first event user interface 700 may be provided in response to the event organizer indicating, via the first calendar user interface 702, an intention to schedule an event within the event organizer's calendar. As shown in FIG. 7A, the first event user interface 700 may include various user interface elements that enable the event organizer to specify details for the event. Such details may include, for example, the title of the event, the desired attendees for the event, the date and time of the event, whether the event is repeating or non-repeating, the location of the event (or whether the event is a virtual event), any desired reminders for the event, and a typed description of the event. For example, according to the embodiment of FIG. 7A, the event is a virtual meeting, titled “Team Lunch Meeting,” that is scheduled to occur on Dec. 21, 2020, from 12:00 pm to 1:00 pm, with a reminder set for 15 minutes before the meeting. In addition, according to embodiments described herein, the first event user interface 700 includes an option to associate third-party resources with the event via interaction with a user interface element 704. According to the exemplary embodiment of FIG. 7A, the user interface element 704 is titled “Include resources like food or transportation.”

FIG. 7B is a schematic view depicting the manner in which the event organizer may click on the user interface element 704 to reveal a corresponding dropdown menu 706 for associating a third-party resource with the event. As shown in FIG. 7B, the dropdown menu 706 may include one or more previous third-party resource selections of the event organizer, such as, for example, a “$10 Gift card” selection. In addition, the dropdown menu 706 may include an option to add a third-party resource to the event. Moreover, those skilled in the art will appreciate that, while a dropdown menu is shown in FIG. 7B, a different type of user interface element may alternatively be used to achieve the same technical effect.

FIG. 7C is a schematic view depicting a third-party resource panel 708 that may open within the first event user interface 700 in response to the event organizer selecting the option to add the third-party resource to the event via the dropdown menu 706. As shown in FIG. 7C, the third-party resource panel 708 enables the event organizer to associate one or more different types of third-party resources with the event. As an example, the event organizer may utilize the third-party resource panel 708 to select various third-party resources that provide food, travel, office supplies, and/or gift cards with the event. In addition, as also shown in FIG. 7C, the event organizer may specify the desired event attendees (e.g., in this example, users named “Sam,” “Talia,” and “Kerri”) who will be able to interact with the third-party resource(s) associated with the event.

FIG. 7D is a schematic view depicting exemplary user interface elements provided by the third-party resource panel 708 in response to the event organizer choosing one or more third-party resources (or one or more types of third-party resources) to associate with the event. In particular, according to the embodiment shown in FIG. 7D, the event organizer has chosen third-party resources that are able to provide food for the event. In various embodiments, once the event organizer has selected the desired third-party resources, the third-party resource panel 708 provides the user interface elements to enable the event organizer to set the parameters for interacting with the third-party resource with respect to the event. Such parameters may include, for example, the third-party resource options, the event attendees' budget for interacting with the third-party resource(s), and the payment method for completing the third-party resource interaction. In some embodiments, the event organizer may also utilize the third-party resource panel 708 to enable the event attendees to individually select and order their food (or other goods) from one or more third-party resources and to have such food delivered to their home, as indicated by the “Service: On-demand delivery” selection shown in FIG. 7D.

In addition, the third-party resource panel 708 may display the maximum charge for interacting with the third-party resources, as determined based on the number of desired event attendees and the specified budget of each event attendee. For example, according to the embodiment shown in FIG. 7D, because there are three desired event attendees in addition to the event organizer, and each event attendee (and the event organizer) is given a budget of $25.00, the maximum charge may be $103.50 (after accounting for service fees).

FIG. 7E is a schematic view depicting the event user interface 700 and the corresponding third-party resource panel 708 once the event organizer has finished associating the third-party resource(s) with the event. In various embodiments, the calendar application then transmits an event invitation including all the details of the event to the event attendees (e.g., in this example, the users named “Sam,” “Talia,” and “Kerri”) in response to the event organizer (e.g., in this example, a user named “Chandra”) clicking a “Save” button 710 within the first event user interface 700.

FIG. 7F is a schematic view depicting an event invitation 712 that is received at a remote computing system that is operated by one of the event attendees (e.g., in this example, the user named “Sam”). As shown in FIG. 7F, the event invitation may be received as an email message within an email inbox folder 714 of the calendar application. Additionally or alternatively, the event invitation (or some variation thereof) may be received as a chat-based message and/or a calendar notification, for example. Moreover, in some embodiments, the event invitation may be received as an email or chat-based message with respect to a separate application other than the calendar application. In such embodiments, the message includes one or more links to the calendar application for enabling the seamless execution of the third-party resource management techniques described herein.

As shown in FIG. 7F, in response to the user clicking on (or navigating to) the email message 712 including the event invitation, a second event user interface 716 may be displayed within the email message 712. The second event user interface 716 may include information about the event, as well as one or more user interface elements for providing user input regarding the event invitation. In particular, the second event user interface 716 may include user interface elements that provide an option to communicate an intention to attend the event (i.e., a “Yes” response), an intention to not attend the event (i.e., a “No” response), or an intention to determine whether to attend the event at some later point in time (i.e., a “Maybe” response).

FIG. 7G is a schematic view depicting the manner in which the second event user interface 716 may provide the event attendee with the option to interact with the third-party resource(s) associated with the event. For example, according to the embodiment shown in FIG. 7G, the option to interact with the third-party resource(s) is provided in the form of a second email message 718 within a resources email folder 720 of the calendar application. However, those skilled in the art will appreciate that the option to interact with the third-party resource(s) may also be provided in any other suitable manner, such as in the form of the second event user interface overlaid onto the calendar user interface corresponding to the event attendee's calendar. Moreover, according to the embodiment shown in FIG. 7G, the option to interact with the third-party resources is provided as a “Redeem” button and a “Decline” button, where user input consisting of clicking on the “Redeem” button enables the event attendee to interact with the third-party resources to order food, and user input consisting of clicking on the “Decline” button prevents the event attendee from interacting with the third-party resource to order food.

FIG. 7H is a schematic view depicting the manner in which the calendar application connects with the third-party resource(s) via a third-party resource connection panel 722 that is provided by (or overlaid onto) the event user interface 716 of the calendar application in response to connection with the third-party resource(s) via corresponding application programming interface(s) (APIs). As shown in FIG. 7H, the third-party resource connection panel 722 includes several user interface elements that enable the event attendee to provide inputs or commands that define the event attendee's interaction with the third-party resource with respect to the event. For example, according to the embodiment shown in FIG. 7H, the event attendee may provide the delivery address and delivery time via the third-party resource connection panel 722. In addition, the event attendee may select the restaurant from which she wishes to order food.

FIG. 7I is a schematic view depicting the manner in which the third-party resource connection panel 722 may display options for selecting goods to order from the third-party resource that is selected by the event attendee. More specifically, according to the embodiment shown in FIG. 7I, the third-party resource connection panel 722 displays meal options provided by “Restaurant 3” in response to the event attendee selecting “Restaurant 3” as the restaurant from which they wish to order food. In addition, the third-party resource connection panel 722 may provide additional details regarding the selected third-party resource (e.g., restaurant), such as, for example, user reviews/ratings and/or the distance between the user's location and the third-party resource location (if the third-party resource has a physical location).

FIG. 7J is a schematic view depicting a third-party resource confirmation message 724 that may be received by the event attendee in response to the event attendee's interaction with the third-party resource. As shown in FIG. 7J, the third-party resource confirmation message 724 may be provided as an email message within the email inbox folder 714 of the calendar application. Additionally or alternatively, the third-party resource confirmation message 724 may be provided as a chat-based message and/or a calendar notification, for example. Moreover, in some embodiments, the third-party resource confirmation message 724 may be provided as an email or chat-based message with respect to a separate application other than the calendar application.

Moreover, in various embodiments, the third-party resource confirmation message 724 includes details regarding the event attendee's interaction with the third-party resource, such as, for example, the budget, the selected third-party resource, and the total cost associated with the interaction. For example, according to the embodiment shown in FIG. 7J, the third-party resource confirmation message 724 provides information regarding the restaurant that was chosen by the event attendee, as well as the meal that was ordered and the total cost of such meal.

In various embodiments, the third-party resource confirmation message 724 further serves as confirmation that the third-party resource data generated as a result of the event attendee's interaction with the third-party resource has been reconciled with the event data corresponding to the event. In this manner, the event is updated within the calendar application such that information relating to the third-party resource is directly associated with the event.

FIG. 7K is a schematic view of a third-party resource interaction notification 726 that may be received by the event organizer via the first calendar user interface 702. In particular, the third-party resource interaction notification 726 may provide information regarding the interaction of one or more event attendees with one or more third-party resources associated with the event. For example, according to the embodiment shown in FIG. 7K, the third-party resource interaction notification 726 informs the event organizer that two event attendees have ordered food for the Team Lunch Meeting and also provides the total cost of the food orders.

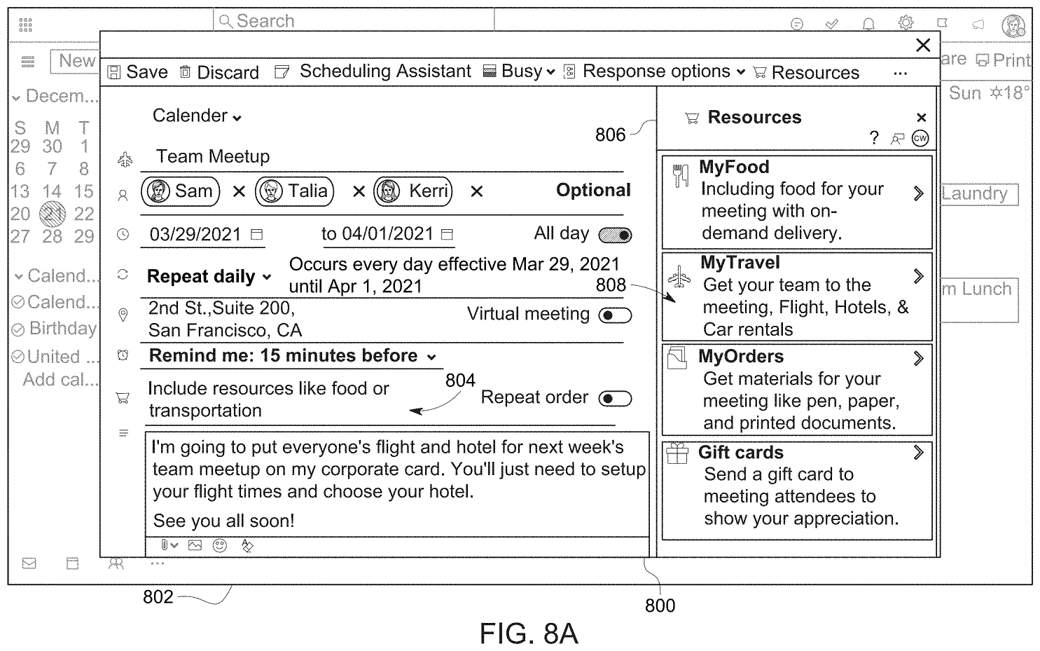

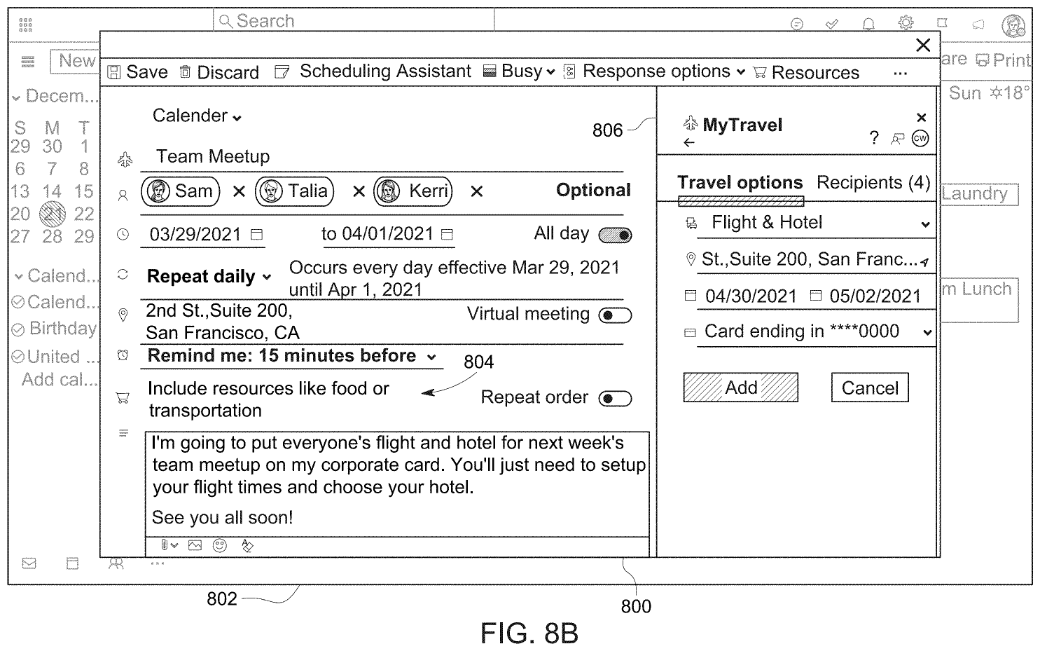

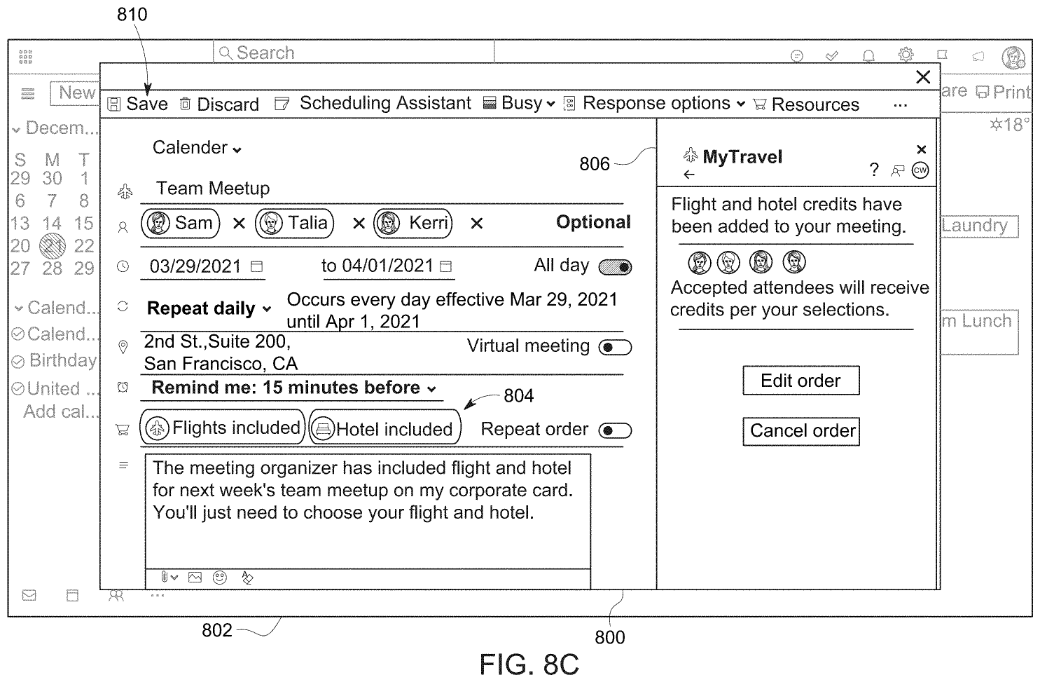

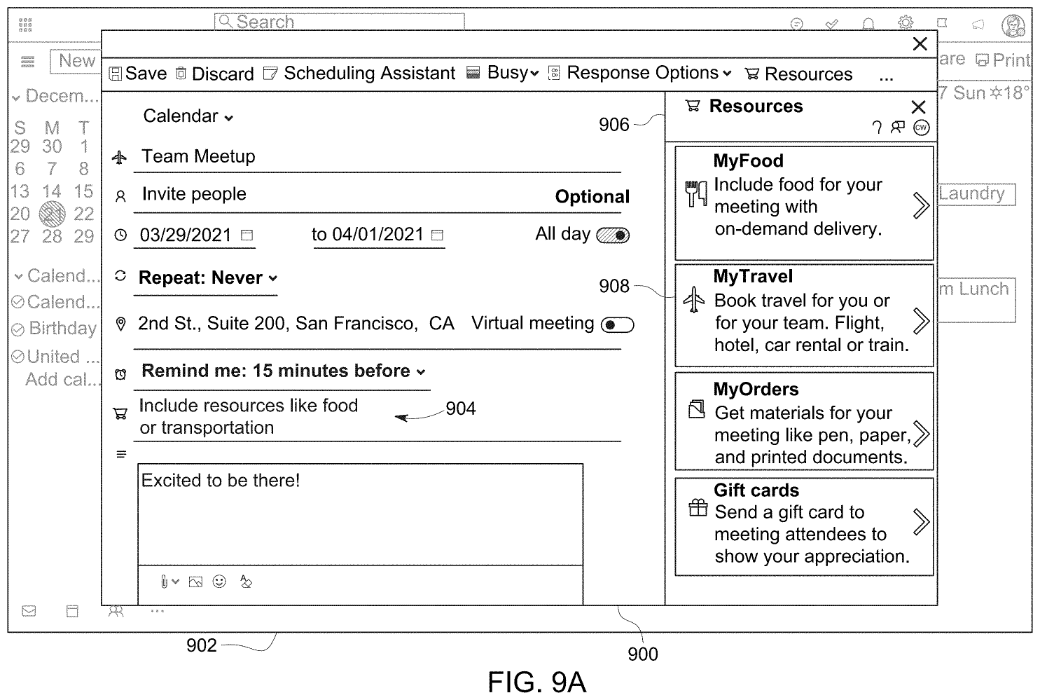

Turning now to the details of the second exemplary implementation, FIGS. 8A-C depict the manner in which the third-party resource management techniques described herein can be used to schedule services, such as, for example, transportation and/or lodging services, for an event. Specifically, FIG. 8A is a schematic view of a first event user interface 800 that is overlaid on top of a first calendar user interface 802 within the context of a calendar application, as viewed from the perspective of the event organizer. In various embodiments, the first event user interface 800 may be provided in response to the event organizer indicating, via the first calendar user interface 802, an intention to schedule an event within the event organizer's calendar. As shown in FIG. 8A, the first event user interface 800 may include various user interface elements that enable the event organizer to specify details for the event. Such details may include, for example, the title of the event, the desired attendees for the event (e.g., in this example, users named “Sam,” “Talia,” and “Kerri”), the date and time of the event, whether the event is repeating or non-repeating, the location of the event (or whether the event is a virtual event), any desired reminders for the event, and a typed description of the event. For example, according to the embodiment of FIG. 8A, the event is an in-person meeting, titled “Team Meetup,” that is scheduled to occur from Mar. 29, 2021 to Apr. 1, 2021 at a remote location, with a reminder set for 15 minutes before the meeting. In addition, according to embodiments described herein, the first event user interface 800 includes an option to associate third-party resources with the event via interaction with a user interface element 804. According to the exemplary embodiment of FIG. 8A, the user interface element 804 is titled “Include resources like food or transportation.” As described with respect to FIG. 7B, the user interface element 804 may include a dropdown menu for selecting one or more third-party resources (or types of third-party resources) to associate with the event. In addition, as described with respect to FIG. 7C, a third-party resource panel 806 may open within the first event user interface 800 in response to the event organizer selecting the option to add a new third-party resource to the event via the dropdown menu. In various embodiments, the third-party resource panel 806 enables the event organizer to associate one or more different third-party resources (or types of third-party resources) with the event. For example, according to the embodiment shown in FIG. 8A, the event organizer may select a “MyTravel” third-party resource button 808, which enables the event organizer to associate one or more third-party resources that can provide, for example, flight, hotel, and/or car rental services for the event.

FIG. 8B is a schematic view depicting exemplary user interface elements provided by the third-party resource panel 806 in response to the event organizer choosing one or more third-party resources (or one or more types of third-party resources) to associate with the event. In particular, according to the embodiment shown in FIG. 8B, the event organizer has chosen third-party resources that are able to provide flight and hotel services for the event. In various embodiments, once the event organizer has selected the desired third-party resources, the third-party resource panel 806 provides the user interface elements to enable the event organizer to set the parameters for interacting with the third-party resource with respect to the event. Such parameters may include, for example, the third-party resource options, the relevant event data for scheduling the desired services (e.g., in this example, the date, time, and location of the event), and the payment method for completing the third-party resource interaction.

FIG. 8C is a schematic view depicting the first event user interface 800 and the corresponding third-party resource panel 806 once the event organizer has finished associating the third-party resource(s) with the event. In various embodiments, the calendar application then transmits an event invitation including all the details of the event to the event attendees (e.g., in this example, the users named “Sam,” “Talia,” and “Kerri”) in response to the event organizer (e.g., in this example, a user named “Chandra”) clicking the “Save” button 810 within the first event user interface 800.

In various embodiments, the event invitation may then be received at remote computing systems operated by the event attendees, enabling such event attendees to interact with the third-party resource(s) to generate third-party resource data for the event, as described herein. In particular, according to the embodiment described with respect to FIGS. 8A-C, the event attendees may utilize the event invitation and the corresponding second event user interface provided by the calendar application to schedule their own flights and book their own hotels for the Team Meetup event.

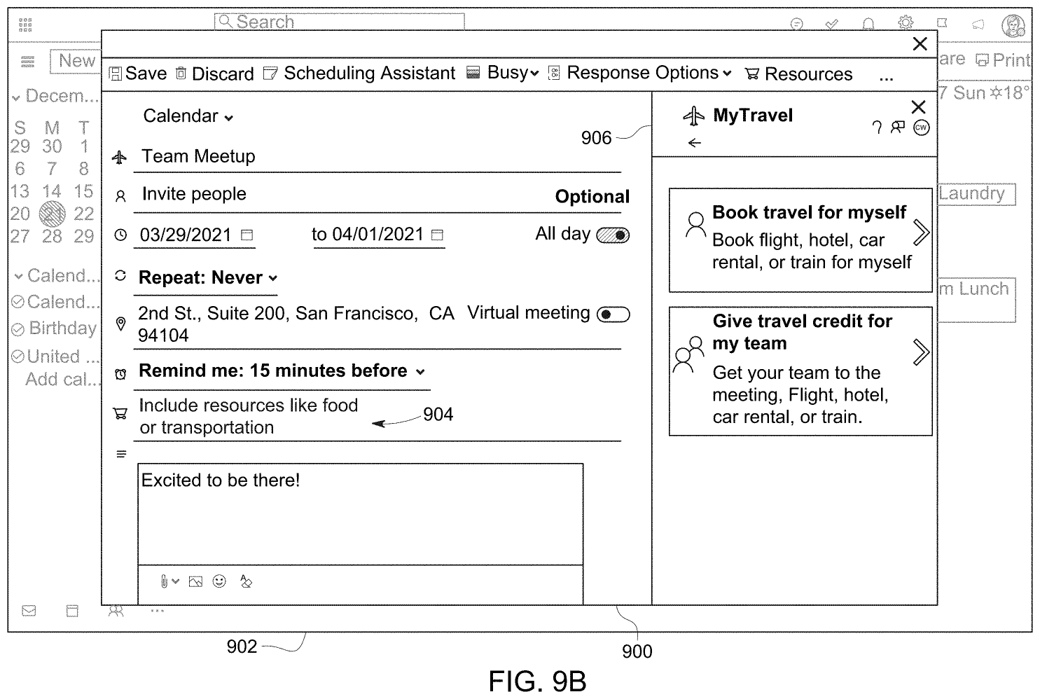

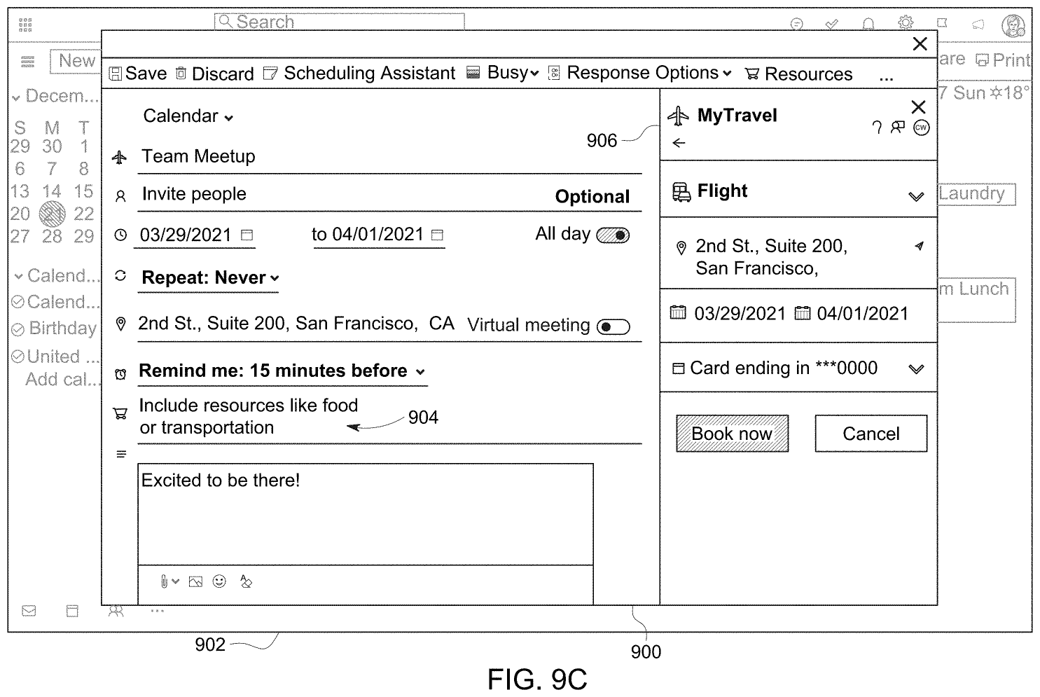

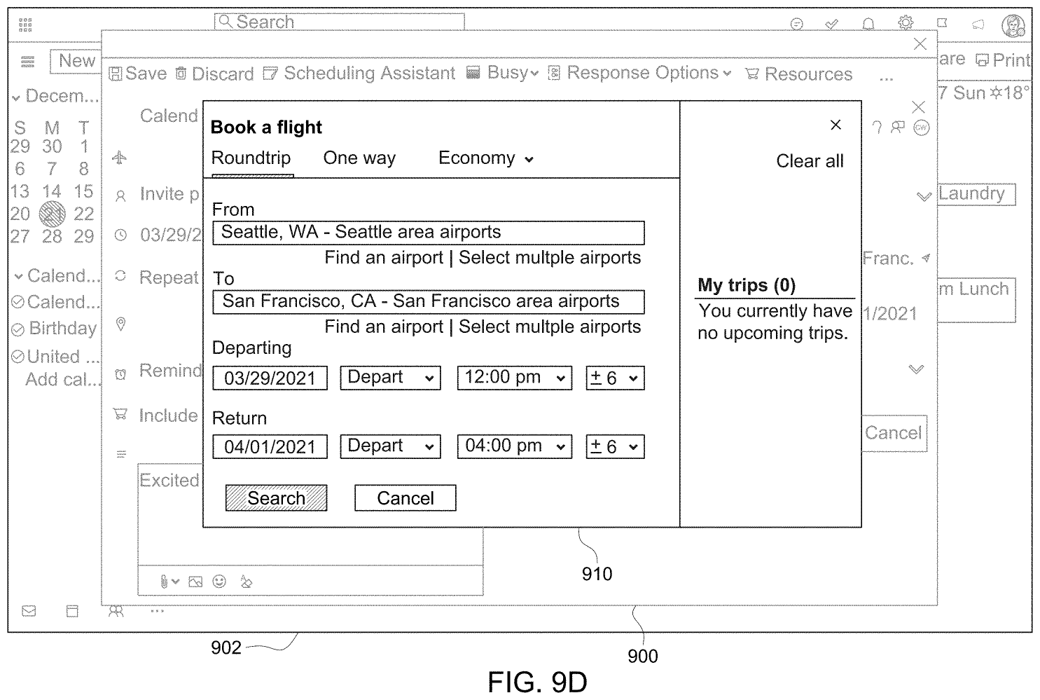

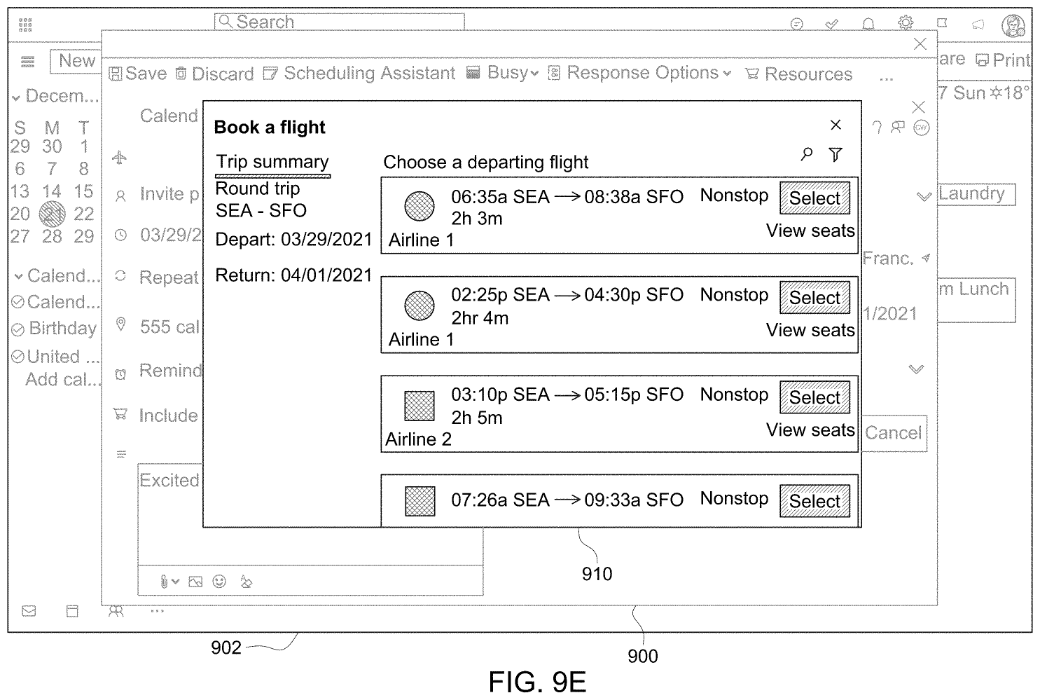

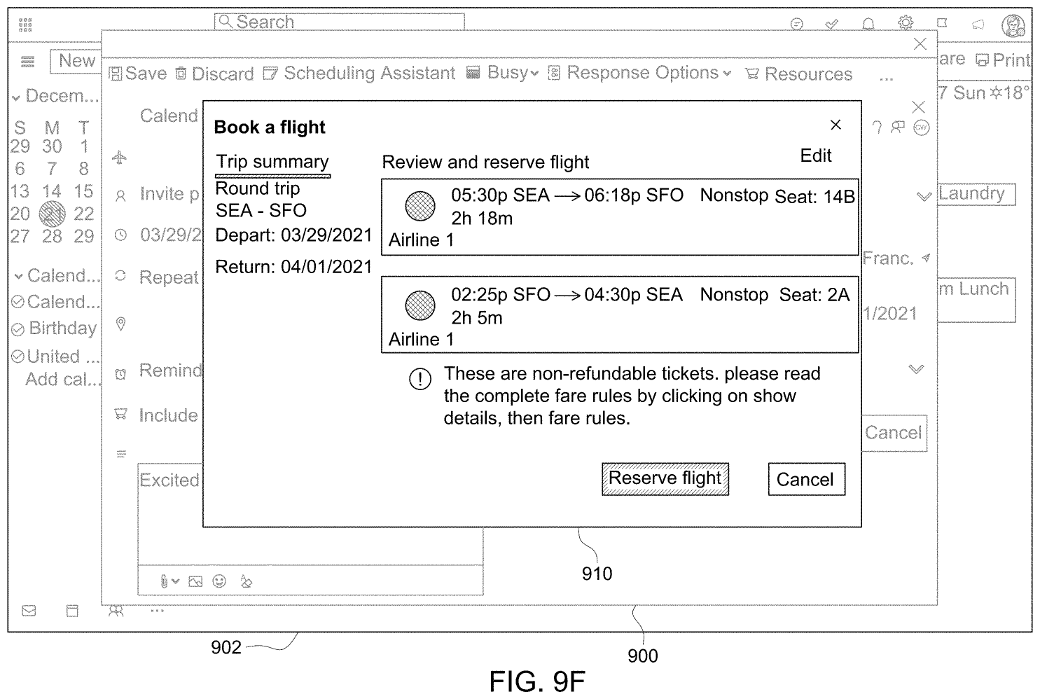

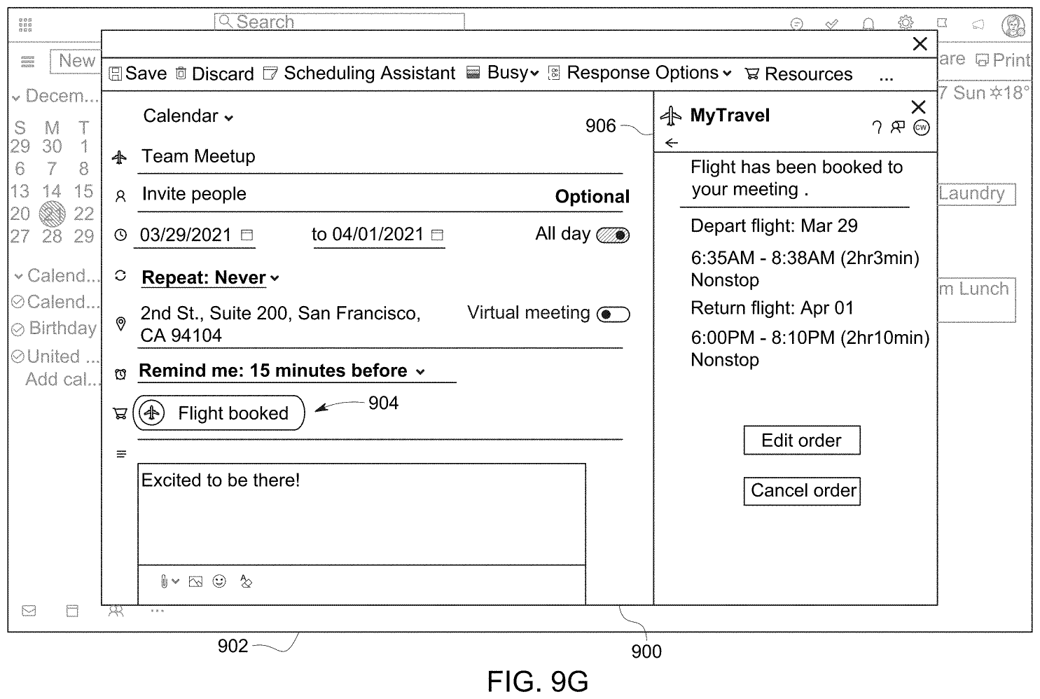

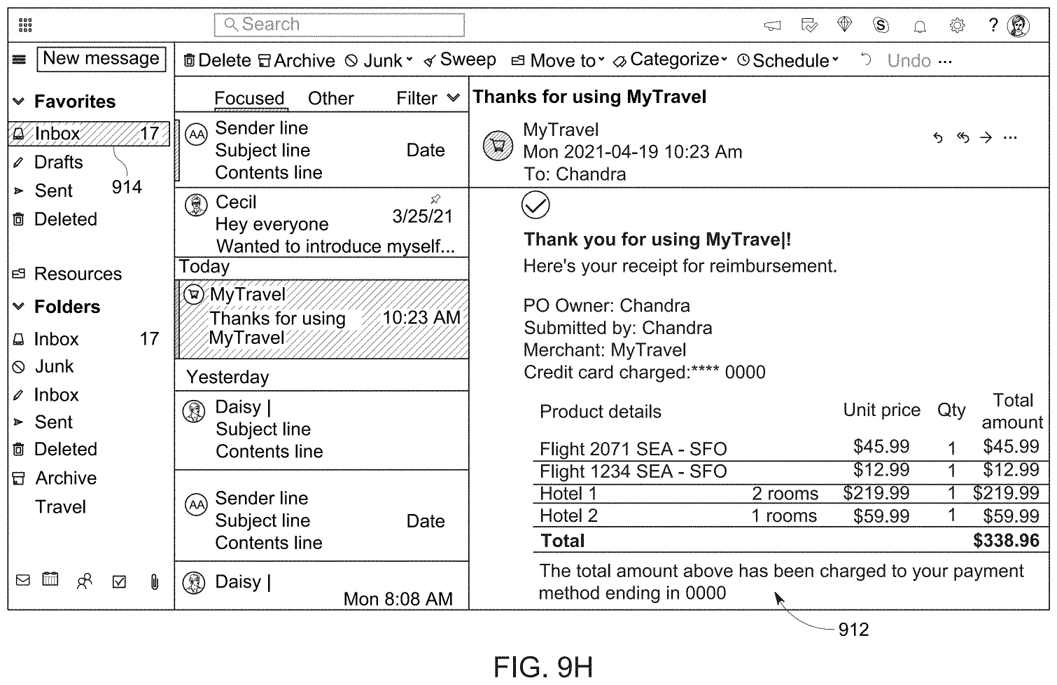

Turning now to the details of the third exemplary implementation, FIGS. 9A-H depict the manner in which the third-party resource management techniques described herein can be used to enable an event organizer to schedule their own desired services, such as, for example, their own roundtrip flight, for an event. Specifically, FIG. 9A is a schematic view of a first event user interface 900 that is overlaid on top of a first calendar user interface 902 within the context of a calendar application, as viewed from the perspective of the event organizer. In various embodiments, the first event user interface 900 may be provided in response to the event organizer indicating, via the first calendar user interface 902, an intention to schedule an event within the event organizer's calendar. As shown in FIG. 9A, the first event user interface 900 may include various user interface elements that enable the event organizer to specify details for the event. Such details may include, for example, the title of the event, the desired attendees for the event, the date and time of the event, whether the event is repeating or non-repeating, the location of the event (or whether the event is a virtual event), any desired reminders for the event, and a typed description of the event. For example, according to the embodiment of FIG. 9A, the event is an in-person meeting, titled “Team Meetup,” that is scheduled to occur from Mar. 29, 2021 to Apr. 1, 2021 at a remote location, with a reminder set for 15 minutes before the meeting. In addition, according to embodiments described herein, the first event user interface 900 includes an option to associate third-party resources with the event via interaction with a user interface element 904. According to the exemplary embodiment of FIG. 9A, the user interface element 904 is titled “Include resources like food or transportation.” As described with respect to FIG. 7B, the user interface element 904 may include a dropdown menu for selecting one or more third-party resources (or types of third-party resources) to associate with the event. In addition, as described with respect to FIG. 7C, a third-party resource panel 906 may open within the first event user interface 900 in response to the event organizer selecting the option to add a new third-party resource to the event via the dropdown menu. In various embodiments, the third-party resource panel 906 enables the event organizer to associate one or more different third-party resources (or types of third-party resources) with the event. For example, according to the embodiment shown in FIG. 9A, the event organizer may select a “MyTravel” third-party resource button 908, which enables the event organizer to associate one or more third-party resources that can provide, for example, flight, hotel, and/or car rental services for the event.

FIG. 9B is a schematic view depicting the manner in which the third-party resource panel 906 may enable the event organizer to select whether to personally interact with the associated third-party resource(s) or to enable the event attendee(s) to interact with the associated third-party resource(s). For example, according to the embodiment shown in FIG. 9B, the third-party resource panel 906 includes user interface elements (e.g., buttons) that enable the event organizer to provide input indicating a desire to either “Book travel for myself” or “Give travel credit for my team.”

FIG. 9C is a schematic view depicting various user interface elements provided by the third-party resource panel 906 in response to the event organizer indicating a desire to personally interact with the third-party resource(s). In particular, the user interface elements may enable the event organizer to set parameters for the interaction with the third-party resource(s) with respect to the event. Such parameters may include, for example, the third-party resource options, the relevant event data for scheduling the desired services (e.g., in this example, the date, time, and location of the event), and the payment method for completing the third-party resource interaction.

FIG. 9D is a schematic view depicting the manner in which the calendar application connects with the third-party resource(s) via a third-party resource connection panel 910 that is provided by (or overlaid onto) the event user interface 900 of the calendar application in response to connection with the third-party resource(s) via corresponding application programming interface(s) (APIs). As shown in FIG. 9D, the third-party resource connection panel 910 includes several user interface elements that enable the event organizer to provide inputs or commands that define the event organizer's interaction with the third-party resource with respect to the event. For example, according to the embodiment shown in FIG. 9D, the third-party resource connection panel 910 displays search options for booking a flight to and from the Team Meetup event, where such search options include the desired airports, as well the desired date and time for departure and arrival.

FIG. 9E is a schematic view depicting the manner in which the third-party resource connection panel 910 enables the event organizer to select a desired service from a list of services that meet the search criteria. Specifically, according to the embodiment shown in FIG. 9E, the third-party resource connection panel 910 enables the event organizer to select a desired departing flight from a list of departing flights, as well as a desired return flight from a list of return flights.

FIG. 9F is a schematic view depicting the manner in which the third-party resource connection panel 910 enables the event organizer to view and confirm the scheduled services before the third-party resource data associated with the third-party resource interaction is reconciled with the event data within the calendar application. Specifically, according to the embodiment shown in FIG. 9F, the third-party resource connection panel 910 displays the departing and return flights selected by the event organizer, as well as an option to either confirm the scheduled service (e.g., “Reserve flight”) or cancel the scheduling of the service.

FIG. 9G is a schematic view of a third-party resource confirmation message that may be provided within the third-party resource panel 906 in response to the event organizer interacting with the third-party resource. In particular, according to the embodiment shown in FIG. 9G, the third-party resource confirmation message is provided within the third-party resource panel 906 in response to the event organizer scheduling the roundtrip flight for the Team Meetup event. As shown in FIG. 9G, the third-party resource confirmation message may include a number of details corresponding to the third-party resource interaction, such as, for example, the flight numbers and the times and dates associated with the flights. In addition, the third-party resource panel 906 may also include user interface elements (e.g., buttons) that enable the event organizer to edit or cancel the scheduled service, if desired.

FIG. 9H is a schematic view of another third-party resource confirmation message 912 that may be received by the event organizer in response to the event organizer's interaction with the third-party resource. As shown in FIG. 9H, the third-party resource confirmation message 912 may be provided as an email message within an email inbox folder 914 of the calendar application. Additionally or alternatively, the third-party resource confirmation message 912 may be provided as a chat-based message and/or a calendar notification, for example. Moreover, in some embodiments, the third-party resource confirmation message 912 may be provided as an email or chat-based message with respect to a separate application other than the calendar application.

Moreover, in various embodiments, the third-party resource confirmation message 912 includes details regarding the event organizer's interaction with the third-party resource, such as, for example, the selected third-party resource and the total cost associated with the interaction. For example, according to the embodiment shown in FIG. 9H, the third-party resource confirmation message 912 provides information regarding the flights that were booked by the event organizer, as well as the itemized and total costs corresponding to the flights.

In various embodiments, the third-party resource confirmation message 912 further serves as confirmation that the third-party resource data generated as a result of the event organizer's interaction with the third-party resource has been reconciled with the event data corresponding to the event. In this manner, the event is updated within the calendar application such that information relating to the third-party resource is directly associated with the event.

Turning now to the details of the fourth exemplary implementation, FIGS. 10A-D depict the manner in which the third-party resource management techniques described herein can be used to enable an event organizer to send a reward or gift to the event attendees. In particular, according to the embodiment shown in FIGS. 10A-D, the third-party resource management techniques are used to provide a gift card to team members during a team meeting. In particular, FIG. 10A is a first event user interface 1000 that is provided within the context of a calendar application, as viewed from the perspective of the event organizer. In various embodiments, the first event user interface 1000 is overlaid on top of a first calendar user interface (not shown) of the calendar application. In addition, in various embodiments, the first event user interface 1000 may be provided in response to the event organizer indicating, via the first calendar user interface, an intention to schedule an event within the event organizer's calendar. As shown in FIG. 10A, the first event user interface 1000 may include various user interface elements that enable the event organizer to specify details for the event. Such details may include, for example, the title of the event, the desired attendees for the event, the date and time of the event, whether the event is repeating or non-repeating, the location of the event, and a typed description of the event. For example, according to the embodiment of FIG. 10A, the event is a meeting, titled “Team Meeting,” that is scheduled to occur on May 8, 2020, at 10:30 am. In addition, according to embodiments described herein, the first event user interface 1000 includes an option to associate third-party resources with the event via interaction with a user interface element 1002. Moreover, the user interface element 1002 may include a dropdown menu for selecting one or more third-party resources (or types of third-party resources) to associate with the event.

FIG. 10B is a schematic view depicting a third-party resource panel 1004 that may open within the first event user interface 1000 in response to the event organizer selecting the option to add a new third-party resource to the event via the dropdown menu. In various embodiments, the third-party resource panel 1004 enables the event organizer to associate one or more different third-party resources (or types of third-party resources) with the event. For example, according to the embodiment shown in FIG. 10B, the event organizer may select a “Gift cards” third-party resource option from a dropdown menu, which enables the event organizer to select one or more third-party resources that can provide gift cards for the event.

FIG. 100 is a schematic view depicting exemplary user interface elements provided by the third-party resource panel 1004 in response to the event organizer selecting the third-party resource(s) (or type of third-party resource) to associate with the event. In particular, according to the embodiment shown in FIG. 100, the user interface elements enable the event organizer to input information relating to the type, delivery date, recipients, and payment method for the gift cards associated with the event. For example, according to the embodiment shown in FIG. 100, the event organizer may specify that the gift card is a $5 gift card for “Coffee Shop,” and that such gift card is to be provided to each event attendee at the scheduled time for the Team Meeting event. Moreover, once the event organizer has entered the relevant information for the third-party resource interaction, the event organizer may click a “Confirm” button. This, in turn, may cause the calendar application to reconcile the third-party resource data generated as a result of the third-party resource interaction with the event data corresponding to the event, as described herein.

FIG. 10D is a schematic view depicting the first event user interface 1000 once the event organizer has finished associating the third-party resource(s) with the event. In various embodiments, the calendar application then transmits an event invitation including all the details of the event to the event attendees (e.g., in this example, the users named “Sam,” “Talia,” and “Kerri”) in response to the event organizer clicking the “Save” button 1006 within the first event user interface 1000.

In various embodiments, the event invitation may then be received at remote computing systems operated by the event attendees, enabling such event attendees to interact with the third-party resource(s) to generate third-party resource data for the event, as described herein. In particular, according to the embodiment described with respect to FIGS. 10A-D, the event attendees may utilize the event invitation and the corresponding second event user interface provided by the calendar application to retrieve their gift cards for the Team Meeting event.

Furthermore, those skilled in the art will appreciate that the third-party resource management techniques described herein can be used for any number of additional use-case scenarios. For example, the third-party resource management techniques may be used to provide chat-based functionalities. Such chat-based functionalities may be provided, at least in part, with respect to a chat-based messaging user interface of the calendar application, such as the “Chat” user interface provided by Microsoft Teams. Such chat-based functionalities may be used to provide educational (or other) resources to one or more team members (or work colleagues), to send a reward, thank you, or other gift to one or more team members, and/or to quickly book services and/or purchase goods for an event, for example. In various embodiments, such chat-based functionalities are provided on demand in response to the user invoking the third-party resource management techniques described herein, such as via user interaction with a user interface element corresponding to the third-party resource management techniques or via the input of textual and/or voice commands indicating a desire to utilize the third-party resource management techniques. Accordingly, those skilled in the art will appreciate that the third-party resource management techniques described herein can be fully integrated into any or all aspects of the calendar application such that the user is able to quickly and efficiently associate third-party resources with one or more events on demand with minimal user input.

As will be appreciated by those skilled in the art, the techniques described herein may enhance users' experiences with respect to events in various ways, both from the perspective of event organizers and event attendees. In particular, the techniques described herein may increase the productivity of users by deeply integrating offline resource management capabilities into the calendar application, as well as enabling such resources to be directly associated with particular calendar events. In this manner, the techniques described herein extend the traditional role of the calendar application as a scheduling intent management hub by transforming the calendar application into essentially an all-in-one hub, meaning that the user can utilize the calendar application to directly manage all the resources associated with events, rather than merely expressing scheduling intentions for such events. Accordingly, the user is able to complete multiple tasks at various levels using the calendar application, without having to continuously switch between different applications and/or websites.

The techniques described herein may also enable the social constructs of in-person meetings to be effectively extended to virtual meetings, such as meetings that occur via videoconference. This is particularly beneficial for hybrid work meetings in which some colleagues attend the meeting in person, while other colleagues attend the meeting virtually. In particular, the ability to easily provide the same goods and/or services to all colleagues attending the meeting, whether in person or virtually, may increase the sense of togetherness or social connection between colleagues.

In general, the techniques described herein may improve the experience of everyone attending a particular event. For example, from the perspective of the event organizer, the techniques described herein simplify and streamline the planning process by enabling third-party resources to be quickly and efficiently linked to the event in a manner that enables input from the event attendees, as well as by automatically calculating all costs associated with such third-party resources and allowing such costs to be expensed using one receipt that consolidates the responses from all the event attendees. From the perspective of the event attendees, the techniques described herein provide a seamless and customized event experience by enabling the event attendees to make their own choices regarding the event within minimal input (e.g., with only a few clicks) and, thus, with minimal hassle.

The techniques described herein may improve event logistics across the board by enabling the ordering of tangible goods and/or the scheduling of services for an event, all within the context of the calendar application. As described herein, such tangible goods may include, for example, the food, supplies, and/or equipment for the event, while such services may include, for example, renting the venue and/or arranging transportation and/or lodging for the event. As more specific examples, the techniques described herein may be used to schedule transit or carpool rides to and from buildings for work events, to purchase equipment for a new employee before a scheduled start date, or to order decorations and other supplies for a party.

In some embodiments, the techniques described herein may further simplify and streamline resource management for an event by providing the option to select particular third-party resource management packages. Such packages may include, for example, large corporate meeting packages, small team meeting packages, party packages, office supplies packages, entertainment packages, new employee packages, conference packages, concert packages, and the like. As will be appreciated by those skilled in the art, any number of different types of packages can be envisioned, and such packages can also be customized to the needs to each user.

In various embodiments, machine learning methods can be used to extend the third-party resource management techniques described herein. For example, in some embodiments, the third-party resource management module may utilize one or more types of machine learning models, such as, for example, supervised machine learning models, unsupervised machine learning models, and/or reinforcement learning models, to effectively learn what third-party resources are mostly likely to be of interest to the user. As an example, the third-party resource management module may utilize such machine learning models to predict that a user may be interested in a particular store if the user is located proximate to the store and the user's history (e.g., the user's email history, chat history, browser history, and/or calendar history) shows that the user has previously ordered the types of goods offered by the store. As another example, the third-party resource management module may utilize such machine learning models to predict that a user may be interested in scheduling a particular type of service if the user's history shows that the user has previously scheduled a similar type of service. As another example, the third-party resource management module may utilize such machine learning models to make broad predictions about similarities between users, such as, for example, predictions based on types of goods and/or services that are typically purchased and/or scheduled at the same time. This may then be provided to the user via the event user interface in the form of a message saying that users who purchase/schedule the particular goods/service typically also like another particular type of goods/service.

Moreover, in various embodiments, the third-party resource management module described herein is integrated into the calendar application in the form of a software add-in that can be invoked during the execution of the calendar application. As an example, for embodiments in which the third-party resource management module is installed as an add-in for a chat-based application that includes scheduling functionalities (such as, for example, Microsoft Teams), the user may invoke the third-party resource management module on demand from the chat user interface and/or the calendar user interface provided by the application. In this manner, the third-party resource management module enables the user to quickly and efficiently manage third-party resources for events at any time.

Furthermore, it should be noted that, while the methods and processes described herein are generally expressed in regard to discrete steps, these steps should be viewed as being logical in nature and may or may not correspond to any specific actual and/or discrete steps of a given implementation. In addition, the order in which these steps are presented in the various methods and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

Of course, while the methods and processes described herein include various novel features of the disclosed subject matter, other steps (not listed) may also be carried out in the execution of the subject matter set forth in these methods and processes. Those skilled in the art will appreciate that the logical steps of these methods and processes may be combined together or split into additional steps. Steps of the above-described methods and processes may be carried out in parallel or in series. Often, but not exclusively, the functionality of a particular method or process is embodied in software (e.g., applications, system services, libraries, and the like) that is executed on one or more processors of computing systems. Additionally, in various embodiments, all or some of the various methods and processes may also be embodied in executable hardware modules including, but not limited to, system on chips (Sot's), codecs, specially designed processors and/or logic circuits, and the like, on a computing system.

As suggested above, each method or process described herein is typically embodied within computer-executable instruction (or code) modules including individual routines, functions, looping structures, selectors and switches (such as if-then and if-then-else statements), assignments, arithmetic computations, and the like, that, in execution, configure a computing system to operate in accordance with the particular method or process However, as suggested above, the exact implementation in executable statement of each of the methods or processes is based on various implementation configurations and decisions, including programming languages, compilers, target processors, operating environments, and the linking or binding operation. Those skilled in the art will readily appreciate that the logical steps identified in these methods and processes may be implemented in any number of ways and, thus, the logical descriptions set forth above are sufficiently enabling to achieve similar results.

While various novel aspects of the disclosed subject matter have been described, it should be appreciated that these aspects are exemplary and should not be construed as limiting. Variations and alterations to the various aspects may be made without departing from the scope of the disclosed subject matter.

### Examples

Example 1 is a calendar application server, including a processor and a computer-readable storage medium operatively coupled to the processor. The computer-readable storage medium includes computer-executable instructions that, when executed by the processor, cause the processor to: (1) enable execution of a calendar application on a first remote computing system corresponding to a first calendar, wherein the first remote computing system is communicably coupled to the calendar application server through a network; (2) provide a first event user interface surfaced on a first display of the first remote computing system in response to a user-initiated creation of an event with respect to a first calendar within the calendar application; (3) in response to a first user command received via the first event user interface, associate a third-party resource with the event within the calendar application; (4) in response to a second user command received via the first event user interface, transmit an event invitation to a second remote computing system corresponding to a second calendar, wherein the second remote computing system is communicably coupled to the calendar application server through the network; (5) enable execution of the calendar application on the second remote computing system; (6) associate the event with the second calendar and provide a second event user interface surfaced on a second display of the second remote computing system in response to a user-initiated acceptance of the event invitation; (7) in response to a third user command received via the second event user interface, connect with the third-party resource associated with the event via an application programming interface corresponding to the third-party resource, wherein the application programming interface is provided within the context of the calendar application; (8) in response to a user interaction with the third-party resource via the application programming interface, generate third-party resource data for the event; and (9) reconcile the third-party resource data with event data corresponding to the event within the calendar application such that the event is updated with respect to the first calendar and the second calendar.

Example 2 includes the calendar application server of example 1, including or excluding optional features. In this example, the third-party resource includes a third-party service or application offering at least one type of goods, and the association of the third-party resource with the event includes an authorization to interact with the third-party resource to select desired goods for the event. In addition, in this example, the generation of the third-party resource data for the event is in response to the selection of the desired goods.

Example 3 includes the calendar application server of example 1 or 2, including or excluding optional features. In this example, the computer-executable instructions, when executed by the processor, cause the processor to associate a number of third-party resources with the event within the calendar application, where each third-party resource includes a third-party service or application offering at least one type of goods, and where the association of the third-party resources with the event includes an authorization to interact with any of the third-party resources to select desired goods for the event. In addition, in this example, the generation of the third-party resource data for the event is in response to the selection of the desired goods with respect to at least one of the third-party resources.

Example 4 includes the calendar application server of any one of examples 1 to 3, including or excluding optional features. In this example, the third-party resource includes a third-party service or application offering a type of service, and the association of the third-party resource with the event includes an authorization to interact with the third-party resource to schedule a desired service for the event. In addition, in this example, the generation of the third-party resource data for the event is in response to the scheduling of the desired service.

Example 5 includes the calendar application server of any one of examples 1 to 4, including or excluding optional features. In this example, the computer-executable instructions, when executed by the processor, cause the processor to associate a number of third-party resources with the event within the calendar application, where each third-party resource includes a third-party service or application offering a type of service, and the association of the third-party resources with the event includes an authorization to interact with any of the third-party resources to schedule at least one desired service for the event. In addition, in this example, the generation of the third-party resource data for the event is in response to the scheduling of the at least one desired service with respect to at least one of the third-party resources.

Example 6 includes the calendar application server of any one of examples 1 to 5, including or excluding optional features. In this example, the computer-executable instructions, when executed by the processor, cause the processor to provide the reconciled event data to the first remote computing system such that the third-party resource data generated as a result of the user interaction with the third-party resource is presented via the first event user interface surfaced on the first display.

Example 7 includes the calendar application server of example 6, including or excluding optional features. In this example, the computer-executable instructions, when executed by the processor, further cause the processor to provide an expense report to the first remote computing system corresponding to the first calendar, where the expense report includes any expenses associated with the user interaction with the third-party resource via the second remote computing system corresponding to the second calendar.

Example 8 includes the calendar application server of any one of examples 1 to 7, including or excluding optional features. In this example, the computer-executable instructions, when executed by the processor, further cause the processor to perform the transmission of the event invitation, the enablement of the execution of the calendar application on a corresponding computing system, the association of the event with a corresponding calendar, the providing of a corresponding event user interface, the connection with the third-party resource, and the generation of corresponding third-party resource data for at least one additional remote computing system. In addition, in this example, the computer-executable instructions, when executed by the processor, cause the processor to reconcile the corresponding third-party resource data received from the second remote computing system and the least one additional remote computing system with the event data corresponding to the event within the calendar application.

Example 9 includes the calendar application server of example 8, including or excluding optional features. In this example, the computer-executable instructions, when executed by the processor, cause the processor to provide the reconciled event data to the first remote computing system such that the third-party resource data generated as a result of the user interactions with the third-party resource is presented via the first event user interface surfaced on the first display.

Example 10 includes the calendar application server of any one of examples 1 to 9, including or excluding optional features. In this example, the computer-executable instructions, when executed by the processor, further cause the processor to connect with the third-party resource associated with the event via the application programming interface corresponding to the third-party resource in response to a fourth user command received via the first event user interface, where the application programming interface is provided within the context of the calendar application, as well as to generate additional third-party resource data for the event in response to a second user interaction with the third-party resource via the application programming interface. In this example, the computer-executable instructions, when executed by the processor, also cause the processor to reconcile the additional third-party resource data with the event data corresponding to the event within the calendar application such that the event is further updated with respect to the first calendar and the second calendar.

Example 11 includes the calendar application server of any one of examples 1 to 10, including or excluding optional features. In this example, the calendar application includes an application with at least one of a calendar functionality, a scheduling functionality, or a time management functionality.

Example 12 is a computer-readable storage medium including computer-executable instructions that, when executed by a processor, cause the processor to: (1) associate a third-party resource with an event within a calendar application in response to a first user command received via an event user interface functionality provided by the calendar application; (2) connect with the third-party resource via an application programming interface corresponding to the third-party resource in response to a second user command received via the event user interface functionality provided by the calendar application, wherein the application programming interface is provided within the context of the calendar application; (3) generate third-party resource data for the event in response to a user interaction with the third-party resource via the application programming interface provided within the context of the calendar application; and (4) reconcile the third-party resource data with event data corresponding to the event within the calendar application.

Example 13 is the computer-readable storage medium of example 12, including or excluding optional features. In this example, the computer-executable instructions, when executed by the at least one processor, cause the at least one processor to receive data relating to the first user command from a first remote computing system corresponding to a first calendar, as well as to receive data relating to the second user command and the user interaction with the third-party resource from a second remote computing system corresponding to the second calendar.

Example 14 includes the computer-readable storage medium of example 12 or 13, including or excluding optional features. In this example, the computer-executable instructions, when executed by the at least one processor, cause the at least one processor to receive data relating to the first user command, the second user command, and the user interaction with the third-party resource from a first remote computing system corresponding to a first calendar.

Example 15 includes the computer-readable storage medium of any one of examples 12 to 14, including or excluding optional features. In this example, the computer-executable instructions, when executed by the at least one processor, cause the at least one processor to: (1) associate a number of third-party resources with the event within the calendar application in response to the first user command received via the event user interface functionality provided by the calendar application; (2) connect with any of the third-party resources via a corresponding application programming interface in response to at least one user command received via the event user interface functionality provided by the calendar application; (3) generate third-party resource data for the event in response to at least one user interaction with any of the third-party resources via the corresponding application programming interface provided within the context of the calendar application; and (4) reconcile the third-party resource data with the event data corresponding to the event within the calendar application.

Example 16 includes the computer-readable storage medium of any one of examples 12 to 15, including or excluding optional features. In this example, the third-party resource includes a third-party service or application offering at least one type of goods; the association of the third-party resource with the event includes an authorization to interact with the third-party resource to select desired goods for the event; and the generation of the third-party resource data for the event is in response to the selection of the desired goods.

Example 17 includes the computer-readable storage medium of any one of examples 12 to 16, including or excluding optional features. In this example, the third-party resource comprises a third-party service or application offering a type of service; the association of the third-party resource with the event includes an authorization to interact with the third-party resource to schedule a desired service for the event; and the generation of the third-party resource data for the event is in response to the scheduling of the desired service.

Example 18 is a method for interacting with a third-party resource associated with an event within a context of a calendar application. The method is implemented in a computing system including a processor and a display operatively coupled to each other. The method includes: (1) executing, via the processor, the calendar application on the computing system; (2) receiving, via the calendar application, an event invitation for an event including an associated third-party resource; (3) receiving, via the calendar application, a first user input including a command to provide an event user interface corresponding to the event; (4) in response to the first user input, providing the event user interface surfaced on the display; (5) receiving, via the event user interface, a second user input including a command to accept the event invitation; (6) in response to the second user input, associating the event with a calendar within the calendar application and providing an option to access the associated third-party resource via the event user interface; (7) receiving, via the event user interface, a third user input including a command to access the third-party resource; (8) in response to the third user input, connecting with the third-party resource through an application programming interface corresponding to the third-party resource, where the application programming interface is provided within the context of the calendar application; (9) receiving, via the event user interface, a fourth user input including a command to interact with the third-party resource via the application programming interface; (10) in response to the fourth user input, interacting with the third-party resource via the application programming interface to generate third-party resource data for the event; and (11) reconciling the third-party resource data with event data corresponding to the event within the calendar application such that the event is updated with respect to the calendar.

Example 19 includes the method of example 18, including or excluding optional features. In this example, receiving the fourth user input including the command to interact with the third-party resource via the application programming interface includes detecting a user selection of at least one good or service offered by the third-party resource, and interacting with the third-party resource via the application programming interface to generate the third-party resource data for the event includes purchasing the at least one good or service for the event.

Example 20 includes the method of example 18 or 19, including or excluding optional features. In this example, the method further includes providing, via the calendar application, at least one reminder to access the third-party resource prior to the event.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A calendar application server, comprising:
a processor; and
a computer-readable storage medium operatively coupled to the processor, the computer-readable storage medium comprising computer-executable instructions that, when executed by the processor, cause the processor to:
enable execution of a calendar application on a first remote computing system corresponding to a first calendar, wherein the first remote computing system is communicably coupled to the calendar application server through a network;
provide a first event user interface surfaced on a first display of the first remote computing system in response to a user-initiated creation of an event with respect to a first calendar within the calendar application;
in response to a first user command received via the first event user interface, associate a third-party resource with the event within the calendar application;
in response to a second user command received via the first event user interface, transmit an event invitation to a second remote computing system corresponding to a second calendar, wherein the second remote computing system is communicably coupled to the calendar application server through the network;
enable execution of the calendar application on the second remote computing system;
associate the event with the second calendar and provide a second event user interface surfaced on a second display of the second remote computing system in response to a user-initiated acceptance of the event invitation;
in response to a third user command received via the second event user interface, connect with the third-party resource associated with the event via an application programming interface corresponding to the third-party resource, wherein the application programming interface is provided within a context of the calendar application;
in response to a user interaction with the third-party resource via the application programming interface, generate third-party resource data for the event; and
reconcile the third-party resource data with event data corresponding to the event within the calendar application such that the event is updated with respect to the first calendar and the second calendar.

2. The calendar application server of claim 1, wherein the third-party resource comprises a third-party service or application offering at least one type of goods, and wherein the association of the third-party resource with the event comprises an authorization to interact with the third-party resource to select desired goods for the event, and wherein the generation of the third-party resource data for the event is in response to the selection of the desired goods.

3. The calendar application server of claim 1, wherein the computer-executable instructions, when executed by the processor, cause the processor to associate a plurality of third-party resources with the event within the calendar application, wherein each of the plurality of third-party resources comprises a third-party service or application offering at least one type of goods, and wherein the association of the plurality of third-party resources with the event comprises an authorization to interact with any of the plurality of third-party resources to select desired goods for the event, and wherein the generation of the third-party resource data for the event is in response to the selection of the desired goods with respect to at least one of the plurality of third-party resources.

4. The calendar application server of claim 1, wherein the third-party resource comprises a third-party service or application offering a type of service, and wherein the association of the third-party resource with the event comprises an authorization to interact with the third-party resource to schedule a desired service for the event, and wherein the generation of the third-party resource data for the event is in response to the scheduling of the desired service.

5. The calendar application server of claim 1, wherein the computer-executable instructions, when executed by the processor, cause the processor to associate a plurality of third-party resources with the event within the calendar application, wherein each of the plurality of third-party resources comprises a third-party service or application offering a type of service, and wherein the association of the plurality of third-party resources with the event comprises an authorization to interact with any of the plurality of third-party resources to schedule at least one desired service for the event, and wherein the generation of the third-party resource data for the event is in response to the scheduling of the at least one desired service with respect to at least one of the plurality of third-party resources.

6. The calendar application server of claim 1, wherein the computer-executable instructions, when executed by the processor, cause the processor to provide the reconciled event data to the first remote computing system such that the third-party resource data generated as a result of the user interaction with the third-party resource is presented via the first event user interface surfaced on the first display.

7. The calendar application server of claim 6, wherein the computer-executable instructions, when executed by the processor, further cause the processor to provide an expense report to the first remote computing system corresponding to the first calendar, wherein the expense report comprises any expenses associated with the user interaction with the third-party resource via the second remote computing system corresponding to the second calendar.

8. The calendar application server of claim 1, wherein the computer-executable instructions, when executed by the processor, further cause the processor to:
perform the transmission of the event invitation, the enablement of the execution of the calendar application on a corresponding computing system, the association of the event with a corresponding calendar, the providing of a corresponding event user interface, the connection with the third-party resource, and the generation of corresponding third-party resource data for at least one additional remote computing system; and
reconcile the corresponding third-party resource data received from the second remote computing system and the least one additional remote computing system with the event data corresponding to the event within the calendar application.

9. The calendar application server of claim 8, wherein the computer-executable instructions, when executed by the processor, cause the processor to provide the reconciled event data to the first remote computing system such that the third-party resource data generated as a result of the user interactions with the third-party resource is presented via the first event user interface surfaced on the first display.

10. The calendar application server of claim 1, wherein the computer-executable instructions, when executed by the processor, further cause the processor to:
in response to a fourth user command received via the first event user interface, connect with the third-party resource associated with the event via the application programming interface corresponding to the third-party resource, wherein the application programming interface is provided within the context of the calendar application;
in response to a second user interaction with the third-party resource via the application programming interface, generate additional third-party resource data for the event; and
reconcile the additional third-party resource data with the event data corresponding to the event within the calendar application such that the event is further updated with respect to the first calendar and the second calendar.

11. The calendar application server of claim 1, wherein the calendar application comprises an application with at least one of a calendar functionality, a scheduling functionality, or a time management functionality.

12. A computer-readable storage medium comprising computer-executable instructions that, when executed by at least one processor, cause the at least one processor to:
associate a third-party resource with an event within a calendar application in response to a first user command received via an event user interface functionality provided by the calendar application;
connect with the third-party resource via an application programming interface corresponding to the third-party resource in response to a second user command received via the event user interface functionality provided by the calendar application, wherein the application programming interface is provided within a context of the calendar application;
generate third-party resource data for the event in response to a user interaction with the third-party resource via the application programming interface provided within the context of the calendar application; and
reconcile the third-party resource data with event data corresponding to the event within the calendar application.

13. The computer-readable storage medium of claim 12, wherein the computer-executable instructions, when executed by the at least one processor, cause the at least one processor to:
receive data relating to the first user command from a first remote computing system corresponding to a first calendar; and
receive data relating to the second user command and the user interaction with the third-party resource from a second remote computing system corresponding to the second calendar.

14. The computer-readable storage medium of claim 12, wherein the computer-executable instructions, when executed by the at least one processor, cause the at least one processor to receive data relating to the first user command, the second user command, and the user interaction with the third-party resource from a first remote computing system corresponding to a first calendar.

15. The computer-readable storage medium of claim 12, wherein the computer-executable instructions, when executed by the at least one processor, cause the at least one processor to:
associate a plurality of third-party resources with the event within the calendar application in response to the first user command received via the event user interface functionality provided by the calendar application;
connect with any of the plurality of third-party resources via a corresponding application programming interface in response to at least one user command received via the event user interface functionality provided by the calendar application;
generate third-party resource data for the event in response to at least one user interaction with any of the plurality of third-party resources via the corresponding application programming interface provided within the context of the calendar application; and
reconcile the third-party resource data with the event data corresponding to the event within the calendar application.

16. The computer-readable storage medium of claim 12, wherein the third-party resource comprises a third-party service or application offering at least one type of goods, and wherein the association of the third-party resource with the event comprises an authorization to interact with the third-party resource to select desired goods for the event, and wherein the generation of the third-party resource data for the event is in response to the selection of the desired goods.

17. The computer-readable storage medium of claim 12, wherein the third-party resource comprises a third-party service or application offering a type of service, and wherein the association of the third-party resource with the event comprises an authorization to interact with the third-party resource to schedule a desired service for the event, and wherein the generation of the third-party resource data for the event is in response to the scheduling of the desired service.

18. A method for interacting with a third-party resource associated with an event within a context of a calendar application, wherein the method is implemented in a computing system comprising a processor and a display operatively coupled to each other, and wherein the method comprises:
executing, via the processor, the calendar application on the computing system;
receiving, via the calendar application, an event invitation for an event comprising an associated third-party resource;
receiving, via the calendar application, a first user input comprising a command to provide an event user interface corresponding to the event;
in response to the first user input, providing the event user interface surfaced on the display;
receiving, via the event user interface, a second user input comprising a command to accept the event invitation;
in response to the second user input, associating the event with a calendar within the calendar application and providing an option to access the associated third-party resource via the event user interface;
receiving, via the event user interface, a third user input comprising a command to access the third-party resource;
in response to the third user input, connecting with the third-party resource through an application programming interface corresponding to the third-party resource, wherein the application programming interface is provided within the context of the calendar application;
receiving, via the event user interface, a fourth user input comprising a command to interact with the third-party resource via the application programming interface;
in response to the fourth user input, interacting with the third-party resource via the application programming interface to generate third-party resource data for the event; and
reconciling the third-party resource data with event data corresponding to the event within the calendar application such that the event is updated with respect to the calendar.

19. The method of claim 18, wherein receiving the fourth user input comprising the command to interact with the third-party resource via the application programming interface comprises detecting a user selection of at least one good or service offered by the third-party resource, and wherein interacting with the third-party resource via the application programming interface to generate the third-party resource data for the event comprises purchasing the at least one good or service for the event.

20. The method of claim 18, further comprising providing, via the calendar application, at least one reminder to access the third-party resource prior to the event.
